(19) United States
(12) Patent Application Publication
(10) Pub. No.: US 2012/0050734 A1
(43) Pub. Date: Mar. 1, 2012

(54) INVERSE-FLUORESCENCE CORRELATION SPECTROSCOPY

(76) Inventors: Stefan Wennmalm, Djursholm (SE); Jerker Widengren, Solna (SE)

(21) Appl. No.: 13/264,651

(22) PCT Filed: Apr. 15, 2010
(86) PCT No.: PCT/EP10/54970

§ 371 Date: Nov. 4, 2011

Related U.S. Application Data
(60) Provisional application No. 61/169,390, filed on Apr. 15, 2009.

(51) Int. Cl. G01J 3/44; G01N 21/64; G01J 3/30

(52) U.S. Cl. 356/301; 356/317; 356/318; 250/459.1

(57) ABSTRACT

A method is disclosed for analyzing particles or biomolecules in a liquid sample, including: detecting a signal and fluctuations in the signal from a detection volume in the sample; wherein the signal is generated from signal-generating molecules in the medium surrounding the particles or biomolecules and the fluctuations are transient reductions in the signal as the particles or biomolecules transit through the detection volume; and analyzing the detected fluctuations to obtain information about the particles or biomolecules in the liquid sample. At least one example embodiment of the present invention relates to a fluorescence correlation spectroscopy system including a laser, a zero-mode waveguide, guiding device for guiding the laser into the zero-mode waveguide, device for collecting fluorescence emission from excited molecules within the waveguide, a detector for detecting the fluorescence emission and means for autocorrelating the detected fluorescence signal, wherein the detector comprises a photomultiplier tube. Moreover, at least one embodiment relates to the use of a fluorescence correlation spectroscopy system for analyzing molecules of interest in a sample by detecting and analyzing fluctuations in a fluorescence signal that is generated from sample molecules surrounding the molecules of interest, wherein the fluctuations are transient reductions in the detected fluorescence signal.

### TECHNICAL FIELD OF THE INVENTION

The invention relates to analysis of diffusing particles and biomolecules in solution or in cells. In biophysics, biochemistry, and cell biology, methods are needed for analyzing the interaction of biomolecules. A particular requirement on such methods is the possibility to measure interactions even at low concentrations, down to nano-molar and lower concentrations.

The invention also relates to the field of analyzing particles that may not be biological, for example particles in solutions and emulsions. Examples are the need to determine the concentration and size of particles in engine-fuels, for environmental and health purposes, or the need for analyzing aggregation of particles in for example cosmetic products such as skin lotions.

It may also be of interest to analyze particles or biomolecules in a solid. How the invention may be applied to such analyses will be clarified below. The description of the invention below will however focus on its application to analysis of particles and biomolecules in solution.

### BACKGROUND ART

One method for analyzing the interaction of biomolecules in solution is Fluorescence Correlation Spectroscopy, FCS. The concept and principal experiments of FCS were presented in 1972 (Elson, 1974; Magde et al., 1972), however the real breakthrough had to await the early 1990's, when FCS was combined with confocal microscopy and later two-photon microscopy (Rigler et al., 1993). Since then about 4000 papers using FCS have been published according to Web of Science, April 2009. FCS instruments are in 2009 built and sold by Zeiss, Leica, Olympus, and Hamamatsu.

In Fluorescence Correlation Spectroscopy (FCS), diffusing dye-labeled biomolecules emit fluorescence bursts as they traverse a diffraction limited open detection volume. Autocorrelation of the fluorescence signal can give information about concentrations (˜nM) and molecular sizes, and about any dynamic process generating fluorescence fluctuations between high- and low-fluorescent states. The theory and first experimental realization of FCS were presented by Magde, Elson and Webb in the early 70's. However it was not until the early 90's that a significantly improved signal to noise ratio enabled FCS to become an important tool in biophysics and cell biology, in academia as well as in industry.

In FCS, a laser is focused by a microscope objective, which generates a focus inside the liquid sample. The axial radius of the laser focus cannot be smaller than about 0.2 μm due to the diffraction limit. The focus can however be adjusted to have a radius of several micrometers. Fluorescent molecules, for example organic fluorophores, labeled biomolecules, or fusions of a protein with a fluorescent protein like GFP, generate fluorescence bursts as they transit through the excitation focus. A part of the emitted fluorescence is collected by the same objective, focused through a pinhole in the image plane, and thereafter focused again onto detectors. Because the emitted fluorescence has slightly longer wavelength than the exciting laser, the collected fluorescence can be spectrally discriminated from scattered laser light by using dicroic mirrors and emission filters between the objective and the pinhole. The final detection volume is restricted both by the dimensions of the laser focus and by the size of the pinhole in the image plane, which in the diffraction limited case results in a detection volume of ˜0.3 f1 (FIG. 1).

The detected fluorescence can give information about the mobility and concentration of the diffusion molecules, and about any dynamic process generating fluorescence fluctuations between high- and low-fluorescent states.

FCS is for example used to analyze interactions between biomolecules: When a small, fluorescently labeled molecule interacts with, or binds to, a larger, unlabeled molecule or particle, the mobility of the smaller molecule will decrease since large molecules have lower mobility than small molecules. In this way the process of binding over time between the smaller, labeled, molecule and the larger, unlabeled molecule can be detected and analyzed (Kinjo and Rigler, 1995).

Furthermore FCS can analyze dynamic processes of molecules generating fluorescence fluctuations between high- and low-fluorescent states. For example conformational fluctuations in nucleic acid molecules have been analyzed, where the fluorophore's proximity to a quencher in certain conformations of the nucleic acid molecule has been utilized (Bonnet et al., 1998).

A version of FCS is Fluorescence Cross-Correlation Spectroscopy, where two excitation foci of different wavelength (often 488 nm and 633 nm) are superimposed in the sample. Interacting partner-molecules are labeled with a 488-excitable dye and a 633-excitable dye respectively, and their respective emissions are spectrally filtered and detected by two separate detectors. This allows analysis of interacting molecules independent of their respective sizes (Bacia et al., 2006).

The described methods and related apparatus according to prior art technology all have their respective disadvantages. A drawback of FCS as described above, as with all fluorescence based methods for analyzing biomolecular interactions, is the necessity of labeling biomolecules with small fluorescent markers. In addition to the effort of finding suitable markers for each specific experiment, and the effort of labeling, a concern is the influence an external probe may have on its host entity. It is therefore an object of the present invention to find a solution to these shortcomings and problems.

### SUMMARY OF THE INVENTION

The general purpose of the first aspect of the present invention, which will be described subsequently in greater detail, is to provide a new method, not requiring labeling of particles or molecules, for obtaining information about particles and molecules in solution.

As a first aspect of the invention, there is provided a method for analyzing particles or biomolecules in a liquid sample, comprising:

detecting a signal and fluctuations in the signal from a detection volume in the sample; wherein the signal is generated from signal-generating molecules in the medium surrounding the particles or biomolecules and the fluctuations are transient reductions in the signal as the particles or biomolecules transit through the detection volume; and

analyzing the detected fluctuations to obtain information about the particles or biomolecules in the liquid sample.

As a second aspect of the invention, there is provided a method for analyzing molecules in a solid material, comprising

scanning a detection volume across the solid material;

detecting a signal generated from the solid material and fluctuations in the signal; wherein the fluctuations arise as reductions in the signal when the molecules are present in the detection volume; and

analyzing the detected fluctuations in the signal from the solid material to obtain information about the molecules.

As a third aspect of the present invention, there is provided a fluorescence correlation spectroscopy system comprising a laser, a zero-mode waveguide, guiding means for guiding the laser into the zero-mode waveguide, means for collecting fluorescence emission from excited molecules within the waveguide, a detector for detecting the fluorescence emission and means for autocorrelating the detected fluorescence signal, wherein the detector comprises a photomultiplier tube or a simple photodiode.

As a fourth aspect of the invention, there is provided the use of a fluorescence correlation spectroscopy system for analyzing molecules of interest in a sample by detecting and analyzing fluctuations in a fluorescence signal that is generated from sample molecules surrounding the molecules of interest, wherein the fluctuations are transient reductions in the detected fluorescence signal.

As a fifth aspect of the present invention, there is provided a method for analyzing a sample, comprising:

detecting at least one signal and fluctuations in the at least one signal from at least one detection volume of the sample; wherein the at least one signal is generated from signal-generating agents in the medium surrounding an analyte and the fluctuations are reductions in the at least one signal generated due to the presence of the analyte in the at least one detection volume; and

analyzing the detected fluctuations to obtain information about the analyte in the sample.

As a sixth aspect of the invention, there is provided a spectroscopy system comprising a laser, a zero-mode waveguide, guiding means for guiding the laser into the zero-mode waveguide, means for collecting at least one signal from excited agents or within the waveguide, detecting means for detecting the at least one signal and means for analyzing the detected at least one signal, wherein the detecting means comprises a photomultiplier tube or a simple photodiode.

As a seventh aspect of the invention, there is provided the use of a spectroscopy system for analyzing molecules of interest in a sample by detecting and analyzing fluctuations in at least one signal that is generated from sample agents surrounding the molecules of interest, wherein the fluctuations are transient reductions in the at least one detected signal.

The proposed solution does not require labeling of the studied particles/biomolecules. Instead the signal from a medium surrounding the particles of interest is analyzed. For each particle/biomolecule that transits through the medium-filled detection volume or where the detection volume is scanned over the location of the particle/biomolecule, the detected signal from the medium will transiently be reduced. By analyzing the signal with ACF, as in standard FCS, and fitting the ACF to an appropriate model, information can be obtained about the concentration and size of particles.

The medium can comprise, or consist of, conventional organic fluorescent molecules, but is not limited to those. Since the only requirement is a high total signal from the medium, it is not a demand that each individual medium-molecule generates a certain number of photons per time unit, as is the case in standard FCS where a high brightness per molecule is required.

Other objects and advantages of the present invention will become obvious to the reader and it is intended that these objects and advantages are within the scope of the present invention.

### BRIEF DESCRIPTION OF THE DRAWINGS

FIG. 1 shows an example of a standard FCS-setup.

FIG. 2 shows the principle of iFCS.

FIG. 3 shows the amplitude in iFCS as a function of the number of particles N.

FIG. 4 shows the intensity traces from measurements on polystyrene microspheres.

FIG. 5 shows autocorrelation curves from iFCS-measurements on particles of different sizes.

FIG. 6 shows iFCS-measurements on a mixture of particle-sizes.

FIG. 7 shows iFCS curves recorded for three different concentrations of 200 nm beads.

FIG. 8 shows how iFCS is dependent on the noise in the signal from the medium.

FIG. 9 shows a cartoon describing the principle of inverse-Fluorescence Cross-Correlation Spectroscopy (iFCCS).

FIG. 10 shows an example of experimental intensity traces in iFCCS.

FIG. 11 shows an example of experimental iFCCS-curves.

FIG. 12 shows the relation between the amplitude of G_{cc}(0)−1 and particle concentration.

FIG. 13 shows iFCCS intensity traces from binding of a biotin-tagged fluorophore to streptavidin-coated microspheres.

### DETAILED DESCRIPTION OF THE INVENTION

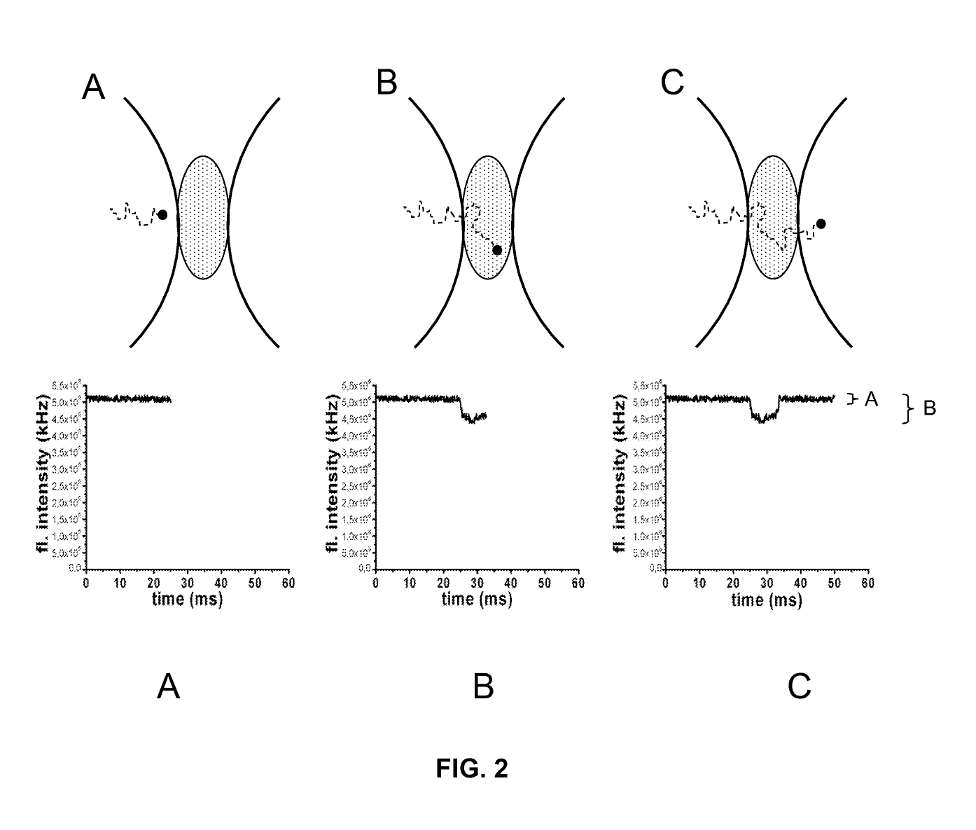

We will now present our invention, a development of Fluorescence Correlation Spectroscopy. The invention, called inverse-FCS or iFCS in short, does not require labeling of the studied particles/biomolecules. Instead the signal from a medium surrounding the particles of interest is analyzed, as opposed to a signal from the particles themselves which is the case in FCS. As a particle transits through the detection volume, a fraction of the medium molecules are displaced, which results in a reduction of the total signal from the medium (FIG. 2). Thus fluorescence fluctuations are generated, with each particle passing the detection volume resulting in a transient reduction in the total medium-signal, as opposed to standard FCS where each passing particle/biomolecule results in fluorescence burst. Like in standard FCS the diffusion coefficient and concentration of particles can be deduced from the autocorrelation function of the detected fluorescence intensity.

If fluorescent dye molecules, like alexa 488, are used as medium, then the experimental setup of iFCS is identical to that of standard FCS. However as will be described in detail below, for enabling detection of higher photon-fluxes from the medium, a photo multiplier-based detector may be used instead of the avalanche photo diodes that have been used so far.

The medium can consist of conventional organic fluorescent molecules, but is not limited to those. Since the only requirement is a high total signal from the medium, it is not a demand that each individual medium-molecule generates a certain number of photons per time unit, as is the case in standard FCS where a high brightness per molecule is required.

Thus, the present invention provides a direct and more sensitive method for estimating the volume of the analyzed particles/biomolecules. The method is able to detect and distinguish a bound (complex) and an unbound fraction of fluorescently labeled proteins, where the mass of the complex can be less than four times the mass of the unbound protein. Also, the method of the present disclosure gives an absolute estimate of the volume of the analyzed proteins.

Further, the present invention provides for an estimate of the degree of fluorescence labeling of the analyzed proteins, so that the pitfall of false affinity-estimation due to the presence of unlabeled proteins—which are believed to be labeled—is avoided. The method also allows the degree of fluorescence labeling to be estimated in the same measurement as the affinity between proteins is estimated.

As a first aspect of the invention, there is provided a method for analyzing particles or biomolecules in a liquid sample, comprising:

detecting a signal and fluctuations in the signal from a detection volume in the sample; wherein the signal is generated from signal-generating molecules in the medium surrounding the particles or biomolecules and the fluctuations are transient reductions in the signal as the particles or biomolecules transit through the detection volume; and

analyzing the detected fluctuations to obtain information about the particles or biomolecules in the liquid sample.

The liquid may for example be a solution or an emulsion.

In the context of the present disclosure, “signal-generating molecules in the medium” refer to molecules capable of generating a detectable signal, e.g. upon excitation with a laser or scattering following irradiation with a laser. The signal-generating molecules in the medium may be the medium itself, such as water, or medium molecules dissolved in the medium, such as low molecular weight organic molecules dissolved in the medium. The signal-generating molecules may be molecules that are inert with respect to the particles or biomolecules in the sample.

Fluctuations as transient reductions refer to fluctuations detected as temporal, “negative spikes” that are larger than the noise in an imaginary baseline of the detected signal.

Thus, the first aspect of the invention provides for inverse Fluorescence Correlation Spectroscopy (iFCS).

In an embodiment of the first aspect, the signal is a fluorescence signal from the signal-generating molecules in the medium. As an example, the signal-generating molecules in the medium may be organic fluorescent molecules.

The organic fluorescent molecules may have an emission wavelength in the visible region, such as an emission wavelength between about 380-750 nm. Further, the organic fluorescent molecules may have an emission wavelength in the UV-region, such as an emission wavelength about 100-380 nm.

In an embodiment of the first aspect, the signal is a Raman scattering signal from the signal-generating molecules in the medium.

In the context of the present disclosure, Raman scattering refers to inelastic scattering of light. As an example, a Raman scattering signal may be a resonance Raman scattering signal, a preresonance Raman scattering signal or an off-resonance Raman scattering signal.

A resonance Raman signal refers to inelastically scattered light, such that the scattered photons have a wavelength different, usually longer, than the wavelength of the incident photons. In general, Raman scattering can take place for any wavelength of the incident light, as opposed to fluorescence. For Resonance Raman scattering however, the wavelength of the incoming light is adjusted such that it or the scattered light coincide with an electronic transition of the molecule, which greatly increases the Raman scattering intensity.

A preresonance Raman signal refers to scattering when the wavelength of the exciting light is close to, but not in complete resonance with the electronic transition of the molecule. The Raman cross-section is higher for pre-resonant molecules than for non-resonant molecules.

An off-resonance Raman scattering signal refers to Raman scattering in which the wavelength of the exciting light is off resonance with the electronic transition of the molecule.

Further, in embodiments, the Raman scattering signal may be a SERS (Surface Enhanced Raman Scattering) signal. A SERS signal from the signal-generating molecules may be enhanced when measuring in the proximity of surfaces.

Signal-generating molecules in the medium from which a Raman scattering signal can be obtained may be present at higher concentrations in the sample compared to e.g. fluorescent dye molecules. As an example, water could be used as the signal-generating molecules in the medium and therefore, the concentration of the signal-generating molecules in the medium could be about 55 M (the concentration of water), which would increase the sensitivity of the method, since medium concentration may result in lower molecular noise from the signal-generating molecules in the medium, thus enabling detection of smaller biomolecules or particles. As an example, the signal-generating molecules in the medium may be carbon disulfide, isoprene, transition-metal complexes or water. These molecules are known to generate high Raman scattering signals. Furthermore, when detecting a Raman signal, the signal may be generated from Raman excitation in the UV spectrum. The UV-spectrum refers to excitation with a wavelength of about 100-400 nm. By excitation in the UV, a smaller detection volume can be created compared to excitation in the visible light, which would increase the sensitivity further

In an embodiment of the first aspect, the detection volume is restricted by the dimensions of a laser focus.

Consequently, the detection volume may be defined by the focus of the laser that is used to excite fluorescent media molecules. Moreover, the final detection volume may be further restricted by the size of a pinhole aperture in the image plane.

In embodiments, the detection volume is defined by utilizing TIR (Total internal reflection) excitation, so that the detection volume is defined by an evanescent field at a surface or an interface.

In an embodiment of the first aspect, the detection volume is between 0.01-1.0 fl, such as about 0.3 fl.

In an embodiment of the first aspect, the detection volume is determined by utilizing STED-microscopy or zero mode waveguides.

In the context of the present disclosure, STED- (Stimulated Emission Depletion-) microscopy refers to a fluorescence microscopy technique which goes beyond the diffraction-limit. In STED-microscopy, the diameter of the spot from which fluorescence is collected is restricted by a doughnut-shaped depletion-laser, superimposed onto the conventional excitation laser. In STED-FCS, a fixed focus is used to study mobile molecules that diffuse through the detection volume.

Further, in the context of the present disclosure zero mode waveguides refer to waveguides constructed on a glass support onto which a film is formed. The film has holes with a diameter that is smaller than about 0.6×λ, where λ is the wavelength of the laser light used to excite signal-generating molecules in the medium in the hole via the glass support. This means that the volume in a hole in which molecules will become excited and emit fluorescence may be in the range ˜2×10⁻¹⁸-2×10⁻²⁰ liters. As an example, a zero mode wave guide may be a waveguide as described in Foquet et al, Journal of Applied Physics (2008) 103, 034301-034309, in which wave guides are constructed on a coverslip, onto which a metal film about 100-200 nm thick is formed. Holes, about 30-200 nm diameter are generated in the film, so that wells with glass-bottom (the coverslip constitutes the bottom) are formed. The volume in a well, in which molecules will become excited and emit fluorescence, will be in the range ˜2×10⁻¹⁸-2×10⁻²⁰ liters, which is about 100 to 10 000 times smaller than diffraction-limited detection volumes which are used in standard FCS. Further, a zero mode waveguide may e.g. be used when detecting SERS from surfaces.

Consequently, utilizing STED-microscopy or zero mode waveguides for defining the detection volume may increase the sensitivity such that smaller particles or biomolecules may be detected.

In an embodiment of the first aspect, analyzing the detected fluctuations comprises calculating the autocorrelation function (ACF) or calculating the standard deviation of the detected fluctuations.

The autocorrelating function (ACF) refers to the function defined as

$$G ( τ ) = \frac{〈 I ( t ) \cdot I ( t + τ ) 〉}{{〈 I ( t ) 〉}^{2}} ,$$

where I(t) is the detected signal intensity at time t, I(t+τ) is the detected signal intensity at a time t+τ, and brackets denote mean value. The signal intensity may be the fluorescence intensity

Fitting an appropriate model to the ACF may allow estimation of the mobility (diffusion constants) and concentrations of the particles or biomolecules.

Further, analyzing the detected fluctuations may comprise calculating the standard deviation of the detected fluctuations.

In an embodiment of the first aspect, analyzing the detected fluctuations comprises intensity distribution analyses such as Photon Counting Histogram (PCH) and Fluorescence Intensity Distribution analysis (FIDA).

Photon Counting Histogram (PCH) refers to a method for analyzing the brightness of different molecular species, diffusing through the detection volume in an instrument identical to or similar to an FCS-instrument. The method was developed by Yan Chen, Joachim Muller, Peter T C So, and Enrico Gratton. It is similar to Fluorescence Intensity Distribution Analysis (FIDA).

Fluorescence Intensity Distribution Analysis (FIDA) refers to a method for analyzing the brightness of different molecular species, diffusing through the detection volume in an instrument identical to or similar to an FCS-instrument. The method was developed by Peet Kask, Kaupo Palo, Dirk Ullmann, and Karsten Gall at Evotec Biosystems AG. It is similar to the Photon Counting Histogram (PCH).

Using PCH and FIDA may thus give information about the studied particles or biomolecules.

In an embodiment of the first aspect of the invention, the concentration of the signal-generating molecules in the medium is above 1 μM. Further, the concentration may be above 10 μM, such as above 50 μM, such as above 100 μM, such as above 200 μM, such as above 400 μM. Thus, the method of the first aspect of the invention allows for high concentrations of the signal-generating molecules in the medium, which thus result in lower relative noise in the medium signal.

In an embodiment of the first aspect of the invention, the concentration of the particles or biomolecules is below 1.1 nM. As an example, the concentration of particles or biomolecules may be below 0.8 nM, such as about 0.5 nM.

Further, in other embodiments, the concentration of the particles or biomolecules are between 1-100 nM.

In an embodiment of the first aspect, the method is further comprising

simultaneously detecting a second or further signal and fluctuations in the second or further signal from the detection volume; wherein the second or further signal is generated from second or further signal-generating agents in the sample and the fluctuations are transient bursts in the second or further signal as the second or further signal-generating agents transit through the detection volume; and wherein

analyzing the detected fluctuations comprises cross-correlating the detected fluctuations in the signal from the signal-generating molecules and the detected fluctuations in the second or further signal from the second or further signal-generating agents to obtain information about the particles or biomolecules in the sample.

Thus, the method of the first aspect of the invention provides for cross-correlation analyses. Cross-correlation analyses involve calculating the cross-correlation function. The cross-correlation function refers to the function defined as

$$G ( τ ) = \frac{〈 {I}_{g} ( t ) \cdot {I}_{r} ( t + τ ) 〉}{〈 {I}_{g} ( t ) 〉 〈 {I}_{r} ( t ) 〉} ,$$

where I_{g} is the signal detected in one detection-channel, where for example green light is selected, Iᵣ is the signal detected in another detection-channel, where for example red light is selected, and brackets denote mean value.

The cross-correlation may be performed using the signal from the signal-generating molecules in the medium and labeled biomolecules and particles, thus giving information about the size ratio between a particle or biomolecule and the detection volume. This allows for e.g. estimation of the volume of the analyzed particles or biomolecules or the size of the detection volume.

Consequently, labeled particles or biomolecules can be analyzed in a surrounding medium, and their emitted fluorescence signal can be cross-correlated with the signal from the surrounding medium, resulting in inverse-Fluorescence Cross-Correlation Spectroscopy (iFCCS). As will be described below, the amplitude of the iFCCS curve can give information about the ratio between the average volume of an analyzed particle and the volume of the detection volume. This gives a direct estimate of the volume of the analyzed particles, or if the size of the analyzed particles is known, an estimate of the volume of the detection volume. This direct estimate of the volume of particles should be more precise than the indirect approach of standard FCS, where the size of particles is estimated via the diffusion coefficient.

As an example, if the volume of the analyzed particles/proteins in a sample was doubled, due to binding of another particle/protein, it would cause the amplitude in iFCCS to be doubled. However if the same analysis were performed using standard FCS where the diffusion time τ_{D} is analyzed, τ_{D} would increase by only 26%, since τ_{D} is proportional to (m₂/m₁)^{1/3}. The measurable parameter in standard FCS is thus less sensitive to changes in particle-volume than the measurable parameter in iFCCS, and accordingly standard FCS is less sensitive in this respect.

Another possibility of using iFCCS is to measure the interaction of small, labeled ligands to larger, unlabeled particles/biomolecules. Cross-correlation in the form of anti-correlation will then appear as the result of binding between ligands and particles. Anti-correlation is a very specific indication of binding which in this manner can be obtained even though only one of the binding partners need to be labeled. Moreover, the fraction of ligand-carrying particles can be determined accurately, since the amount of unlabeled and labeled particles are estimated independently.

As an example, the second or further signal-generating agents may be the particles in the sample or second or further signal-generating molecules.

The second or further signal-generating molecules may be the biomolecules in the sample, such as ligands for the biomolecules or particles.

As an example, the second or further signal may comprise a fluorescence signal or a Raman signal from the particles or biomolecules in the liquid sample. The signal may for example be an autofluorescence signal from the particles or biomolecules or a signal from an fluorescent dye attached to the particles or biomolecules.

Further, the detected signal from the signal-generating molecules in the medium and/or the second or further signal from the second or further signal-generating agents may be the fluorescence lifetime, a polarization or an emission spectrum.

In embodiments, the second or further signal is generated from molecules other than the particles or biomolecules, such as generated from ligands that bind to the particles and molecules. This provides for anti-correlation analyses.

As an example, the second or further signal may be two different signals from two different ligands in the sample, such that binding of the ligands to the particle or biomolecule may be analyzed. The two ligands may thus be labeled with fluorophores with different emission spectra that also are different from the emission spectra of the signal-generating molecules in the medium.

In an embodiment of the first aspect, the particles or biomolecules are labeled.

Further, in an embodiment of the first aspect, the particles or biomolecules are unlabeled.

Consequently, both labeled and unlabeled particles or biomolecules may be used in the method according to the first aspect of the invention. Thus, the method according to the first aspect does not require the analyte of interest to be detectably labeled, since the signal from the signal-generating molecules in the medium are analyzed.

Further, according to the present disclosure, the detection volume may be scanned across a liquid sample, e.g. by scanning a focused laser light across or through a sample. Alternatively or as a complement, the sample itself may be scanned while e.g. a focused laser beam is being maintained in the same position. In this way the detection volume may be moved across a sample, thus providing analyses in several parts of the same sample which provides for high-throughput analyses

It is also to be understood that the methods of the present disclosure may be performed in combination with TIR (total internal reflection) excitation, such that the detection volume is defined by an evanescent field at a surface or interface.

The approach of iFCS can also be applied also to a solid. The laser focus can be scanned across a solid consisting of the particles or biomolecules of interest, embedded in a matrix. The particles/biomolecules would not give rise to a signal, but the matrix would be such that it gave rise to a strong signal. Fluctuations in the detected signal would then arise, as the signal would decrease each time the focus was scanned across a particle/biomolecule. The ACF would be calculated and analyzed. As when applied to diffusion, iFCS could in this way be used to estimate particle concentrations and particle sizes in a solid.

Our description of iFCS in the exemplary embodiments and in the examples below will however focus on its application in solution and also in cells

Thus, as a second aspect of the invention, there is provided a method for analyzing molecules in a solid material, comprising

scanning a detection volume across the solid material;

detecting a signal generated from the solid material and fluctuations in the signal; wherein the fluctuations arise as reductions in the signal when the molecules are present in the detection volume; and

analyzing the detected fluctuations in the signal from the solid material to obtain information about the molecules.

The terms and definitions used in the relation to the second aspect of the invention are the same as used in the first aspect above.

In an embodiment of the second aspect, the signal is a fluorescence signal.

In an embodiment of the second aspect, the detection volume is restricted by a laser focus. Further, the detection volume may be restricted by a pinhole in the image plane.

In an embodiment of the second aspect, analyzing the detected signal comprises calculating the autocorrelation function (ACF) or calculating the standard deviation of the detected fluctuations.

In an embodiment of the second aspect, the molecules are selected from the group consisting of particles and biomolecules.

Further, as an embodiment of the second aspect, there is provided

a method for analyzing particles or biomolecules in a solid, comprising

scanning a laser focus across a solid comprising the particles or biomolecules embedded in a matrix;

detecting a signal from the matrix and fluctuations in the signal that arise as a decrease in the signal when the focus is scanned across particles or biomolecules; and

calculating and analyzing the autocorrelation function (ACF) from the detected fluctuations for estimating the concentration and/or size of the particles or biomolecules. The signal may be a fluorescence signal.

As a third aspect of the present invention, there is provided a fluorescence correlation spectroscopy system comprising a laser, a zero-mode waveguide, guiding means for guiding the laser into the zero-mode waveguide, means for collecting fluorescence emission from excited molecules within the waveguide, a detector for detecting the fluorescence emission and means for autocorrelating the detected fluorescence signal, wherein the detector comprises a photomultiplier tube or a simple photodiode.

The terms and definitions used in relation to the third aspect of the invention are the same as used in the first and second aspects above.

According to the present disclosure, the guiding means may be means for focusing the laser, such as an objective or lens. An objective or lens may also be the collecting means. Thus, the same objective or lens may be used as both guiding means and collecting means.

Further, an objective or lens may be used as guiding means without focusing the laser, but instead used for collimating divergent laser light and guiding the collimated light into the waveguide.

The guiding means may also comprise means for generating an array of laser foci in the sample.

Further, the detector may also comprise a camera. As an example, the camera may be arranged such that one or several pixels constitute a pinhole, which means that several detection volumes may be analyzed simultaneously, e.g. in combination when an array of foci is used as guiding means.

Moreover, the detector may comprise an Avalanche Photo Diode (APD).

It has come to the inventors insight that a FCS-system comprising a zero-mode waveguide in combination with a photomultiplier tube (a PMT) or a simple photodiode is especially adapted for performing the methods of the present invention. The zero mode waveguide provides for a reduced detection volume and the PMT provides for a decreased relative noise level, thus providing a system having high sensitivity when performing the methods of the present disclosure.

In the context of the present disclosure, a simple photodiode refers to a photodiode that gives a current as the output signal and which can detect count rates of more than 10¹³ Hz.

In an embodiment of the third aspect, the photomultiplier tube is in DC-mode.

A photomultiplier (PMT) in DC-mode refers to PMT used such that it gives a current as output signal. In DC-mode, the PMT can detect light intensities of >10¹³ photons/s, which is about 10⁶ times more than what APDs (Avalanche Photo diodes) commonly used in FCS-instruments are capable of.

As an example, a PMT in DC-mode may be a PMT fed with low voltage.

Further, the PMT in DC-mode may be a PMT where the output signal in form of a current is coupled to an amplifier which is coupled to an analogue-to-digital converter.

As a fourth aspect of the invention, there is provided the use of a fluorescence correlation spectroscopy system for analyzing molecules of interest in a sample by detecting and analyzing fluctuations in a fluorescence signal that is generated from sample molecules surrounding the molecules of interest, wherein the fluctuations are transient reductions in the detected fluorescence signal.

The terms and definitions used in relation to the fourth aspect of the invention are the same as used in the other aspects above.

The fourth aspect is based on the insight that a conventional FCS-system may be used for performing the methods of the present disclosure.

In an embodiment of the fourth aspect, the system comprises a laser, guiding means for guiding the laser into a sample, means for collecting fluorescence emission from the sample, a detector for detecting the fluorescence emission and means for autocorrelating the detected fluorescence signal.

In an embodiment of the fourth aspect, the detector comprises a photomultiplier tube or a simple photodiode.

Further, in an embodiment of the fourth aspect, the system is further comprises a zero-mode waveguide.

As a fifth aspect of the present invention, there is provided a method for analyzing a sample, comprising:

detecting at least one signal and fluctuations in the at least one signal from at least one detection volume of the sample; wherein the at least one signal is generated from signal-generating agents in the medium surrounding an analyte and the fluctuations are reductions in the at least one signal generated due to the presence of the analyte in the at least one detection volume; and

analyzing the detected fluctuations to obtain information about the analyte in the sample.

The terms and definitions used in relation to the fifth aspect of the invention are the same as used in the other aspects above.

The at least one signal may be one signal. Further, the at least one detection volume may be one detection volume.

The signal-generating agents may be signal-generating molecules. Further, the signal-generating agents may be quantum dots.

The signal generating agents may be different signal-generating agents, such as two different signal-generating agents.

Quantum dots refer to inorganic semiconductor nanoparticles that generate a signal, such as a fluorescence signal, upon excitation with e.g. a laser.

An analyte refers to a molecule or a particle that is studied in the sample. Information obtained about the analyte may for example be the size, concentration, mobility, binding of ligands to the analyte etc. The analyte may for example be biomolecules, such as proteins and polymers, or particles

The reductions in the signal may for example be temporal, “negative spikes” of an imaginary baseline in the detected signal.

Thus, the fifth aspect of the invention provides for inverse Fluorescence Correlation Spectroscopy (iFCS).

In an embodiment of the fifth aspect, the sample is a solid sample and the fluctuations are generated by means of scanning the detection volume in the sample.

This may provide information or about analyte concentration and analyte size in a solid sample. The signal-generating agents in the medium may thus form a matrix surrounding the analyte in a solid and having the capacity of generating a signal.

In an embodiment of the fifth aspect, the sample is a liquid sample and the fluctuations are transient reductions in the at least one signal as the analyte transits through the detection volume. The liquid sample may for example be an emulsion or solution.

In an embodiment of the fifth aspect, the at least one signal is a fluorescence signal from the signal-generating agents. As an example, the signal-generating agents in the medium may be fluorescent dye molecules.

In a further embodiment of the fifth aspect, the at least one signal is a Raman scattering signal. As an example, a Raman scattering signal may be a resonance Raman scattering signal, a preresonance Raman scattering signal or an off-resonance Raman scattering signal.

Furthermore, the at least one signal may be at least one fluorescence signal and at least one Raman scattering signal from the signal generating agents, which may thus be generated from two different signal generating agents. This provides for the detection of strong signals from the at least one detection volume.

As an example, when detecting a Raman scattering signal, the signal-generating agents may be carbon disulfide, isoprene, transition-metal complexes or water. Further, the signal may be generated by exciting the signal-generating agents in the medium by means of UV-light.

In an embodiment of the fifth aspect, the at least one detection volume is restricted by the dimensions of a laser focus. Moreover, the detection volume may be further restricted by using a pinhole in the image plane.

In an embodiment of the fifth aspect, the detection volume is between 0.01-1.0 fl, such as between 0.2-0.5 fl.

Further, in an embodiment of the fifth aspect, the at least one detection volume is defined by utilizing STED-microscopy or zero mode waveguides.

Moreover, the at least one detection volume may be restricted by one or several evanescent excitation fields, generated by total internal reflection of an excitation light source, and in the image plane by one or several pinholes, or by the projected sizes of detector elements in a camera or detector array.

In embodiments of the fifth aspect, analyzing the detected fluctuations comprises calculating the autocorrelation function (ACF) or calculating the standard deviation of the detected fluctuations.

Further, analyzing the detected fluctuations may comprise calculating the standard deviation of the detected fluctuations.

In further embodiments of the fifth aspect, analyzing the detected fluctuations comprises intensity distribution analyses such as Photon Counting Histogram (PCH) and Fluorescence Intensity Distribution analysis (FIDA).

In an embodiment of the fifth aspect, the concentration of the signal-generating agents in the medium is above 1 μM. Further, the concentration of the signal-generating molecules in the medium may be above 2 μM, such as above 5 μM, such as above 10 μM, such as above 25 μM, such as above 50 μM, such as above 100 μM.

In an embodiment of the fifth aspect, the concentration of the analyte in the sample is between 0.5 nM and 1.0 mM.

As an example, the concentration of the analyte in the sample may be between 1.0 nM and 100 μM.

As an example, in a diffraction limited detection volume, the concentration of the analyte may be between about 1 μM and 1 μM, such as between about 1.0 nM and 1.0 μM. Further, when using a zero mode waveguide for limiting the detection volume, the concentration of the analyte may be between about 10 nM and 0.5 mM, such as between about 100 nM and 100 μM.

In a further embodiment of the fifth aspect, the method is further comprising:

simultaneously detecting a second or further signal and fluctuations in the second or further signal from the at least one detection volume; wherein the second or further signal is generated from second or further signal-generating agents in the sample and the fluctuations are transient bursts in the second or further signal as the second or further signal-generating agents transit through the at least one detection volume; and wherein

analyzing the detected fluctuations comprises correlating the at least one detected signal from the signal-generating agents in the medium with the detected fluctuations in the second or further signal from the second or further signal-generating agents to obtain information about the analyte in the sample.

Second or further signal-generating agents may be second or further signal generating molecules. Further, second or further signal-generating agents may be quantum dots.

Correlating the at least one detected signal may comprise calculating the autocorrelation function (ACF) or calculating the standard deviation of the detected fluctuations.

Thus, the method of the fifth aspect of the invention provides for cross-correlation analyses, such as inverse-Fluorescence Cross-Correlation Spectroscopy (iFCCS) discussed above. As an example, the second or further signal-generating agents may be the analyte. Thus, the cross-correlation may be performed using the signal from signal-generating agents in the medium and the signal from a labeled analyte, which may provide information about the size-ratio between the analyte and the detection volume. Further, the cross-correlation may be performed using the signal from the signal-generating agents in the medium and signals from a small, dye-labeled ligands that interacts with the analyte. The signal from the ligand may for example be two different emissions signals from two different ligands, such that binding of the ligands to the analyte may be analyzed. Thus, the second or further signal-generating agents may be different.

Binding between the ligand or ligands and the analyte may in this case result in anti-correlation, a very sensitive indication of binding. Thus, binding between ligand and analyte may be analyzed by means of cross-correlation with the analyte being unlabeled.

Consequently, in embodiments, the second or further signal is generated from molecules other than the analyte, such as from ligands binding to the analyte.

When performing cross-correlation analyses in a diffraction limited detection volume, the concentration of the analyte may be between about 1.0 μM and 2 μM, such as between about 0.8 nM and 25 nM. Further, when performing cross-correlation analyses using a zero mode waveguide for limiting the detection volume, the concentration of the analyte may be between about 10 nM and 0.5 mM, such as between about 0.5 μM and 5 μM.

In embodiments of the fifth aspect, the analyte is unlabeled.

In further embodiments of the fifth aspect, the analyte is labeled.

As a sixth aspect of the invention, there is provided a spectroscopy system comprising a laser, a zero-mode waveguide, guiding means for guiding the laser into the zero-mode waveguide, means for collecting at least one signal from excited agents or a scattered signal within the waveguide and detecting means for detecting the at least one signal and means for analyzing the at least one detected signal, wherein the detecting means comprises a photomultiplier tube or a simple photodiode.

The excited agents may be excited molecules.

In embodiments of the sixth aspect, the at least one signal is a fluorescence signal and/or a Raman scattering signal.

Further, the scattering signal may be from molecules within the waveguide. The scattering signal may be a signal generated from Raman scattering, such as resonance Raman scattering, preresonance Raman scattering or off-resonance Raman scattering.

As an example, the photomultiplier tube may be in DC-mode. Further, for detecting Raman scattering, the photomultiplier tube may be in photon-counting mode or DC-mode.

The guiding means may also comprise means for generating an array of laser foci in the sample.

Further, the detector may also comprise a camera. As an example, the camera may be arranged such that one or several pixels constitute a pinhole, which means that several detection volumes may be analyzed simultaneously, e.g. in combination when an array of foci is used as guiding means.

In further embodiments of the sixth aspect, the means for analyzing the detected at least one signal comprises autocorrelation means.

The autocorrelation means may for example be a correlator board.

As a seventh aspect of the invention, there is provided the use of a spectroscopy system for analyzing agents of interest in a sample by detecting and analyzing fluctuations in at least one signal that is generated from sample molecules surrounding the agents of interest, wherein the fluctuations are transient reductions in the detected at least one signal.

The agents of interest may for example be molecules or quantum dots.

As an example, the sample agents surrounding the molecules of interest may be organic fluorescent dyes or quantum dots, or molecules that generate a Raman signal.

In an embodiment of the seventh aspect, the at least one signal is a fluorescence signal and/or a Raman scattering signal.

In embodiments of the seventh aspect, the system further comprises a zero-mode waveguide.

In an embodiments of the seventh aspect, the detecting means comprises a photomultiplier tube or a simple photodiode.

Further, in embodiments of the seventh aspect, the means for analyzing the detected at least one signal comprises autocorrelation means.

### DESCRIPTION OF THE DRAWINGS

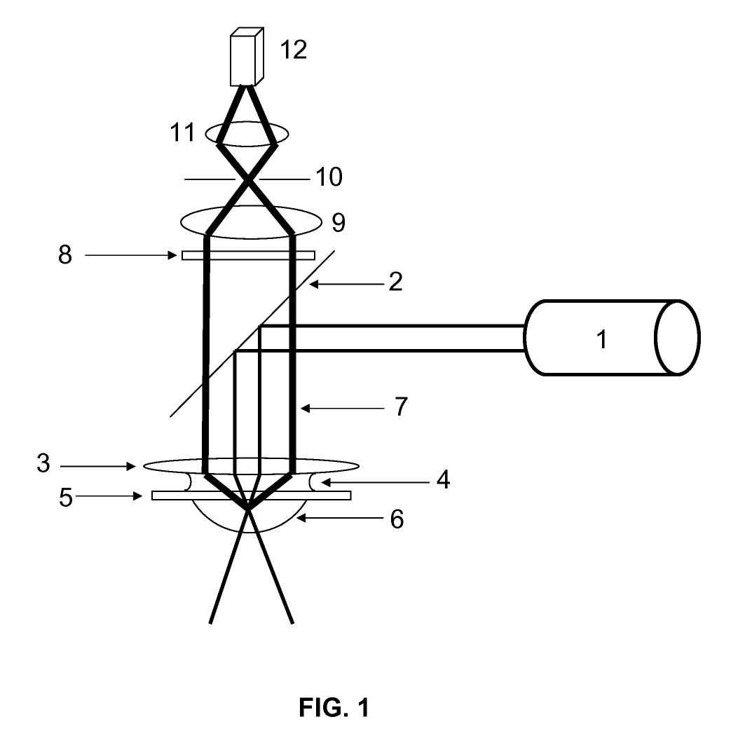

### FIG. 1: Example of a Standard FCS-Setup.

Description of a common experimental setup for FCS. Laser light from the laser (1) is reflected by a dicroic mirror (2) and focused by a microscope objective (3) via immersion water (4) and a coverslip (5) into a sample (6) containing diffusing fluorescent molecules. The emitted fluorescence light (7) from fluorophores diffusing through the excitation focus is collected by the same objective (3) and transmitted through the dicroic mirror (2). An emission filter (8) selects fluorescence emission and blocks scattered laser light. The emission is then focused via a lens (9) through a pinhole (10), which discriminates out-of-focus photons, and focused via another lens (11) onto a photo detector (12). From the detected fluorescence light the autocorrelation function (ACF) is calculated. Fitting of the ACF to an appropriate model gives information about concentrations and mobilities of the diffusing molecules, and about fluorescence fluctuations that may appear as molecules fluctuate between high- and low-fluorescent states.

FIG. 2: The Principle of iFCS.

Principle of iFCS. The hour-glass shape is the focused laser beam, and the ellipse is the medium-filled detection volume which in iFCS (as in standard FCS) is confined by both the laser dimensions and the pinhole in the image plane. a) A high fluorescence signal is detected from the medium (in our experiments 400 μM alexa 488 fluorophores) present in the detection volume. b) The signal is reduced upon the entrance of a non-fluorescent particle into the detection volume. c) The time during which the signal is reduced corresponds to the characteristic diffusion time of the particle through the detection volume. As in standard FCS, the fluorescence fluctuations are analyzed by calculating the autocorrelation function (ACF) of the detected fluorescence intensity, which after fitting to an appropriate model gives the mobilities and concentrations of the particles/biomolecules in the sample.

The sensitivity of iFCS can be enhanced, i.e. even smaller particles can be analyzed, if the ratio between “B” (the negative impact of a transiting particle on the total signal) and “A” (the noise in the total signal) in the figure is increased. This ratio can be increased by increasing the number of detected photons per time unit, by increasing the concentration of medium-molecules, or by decreasing the size of the detection volume.

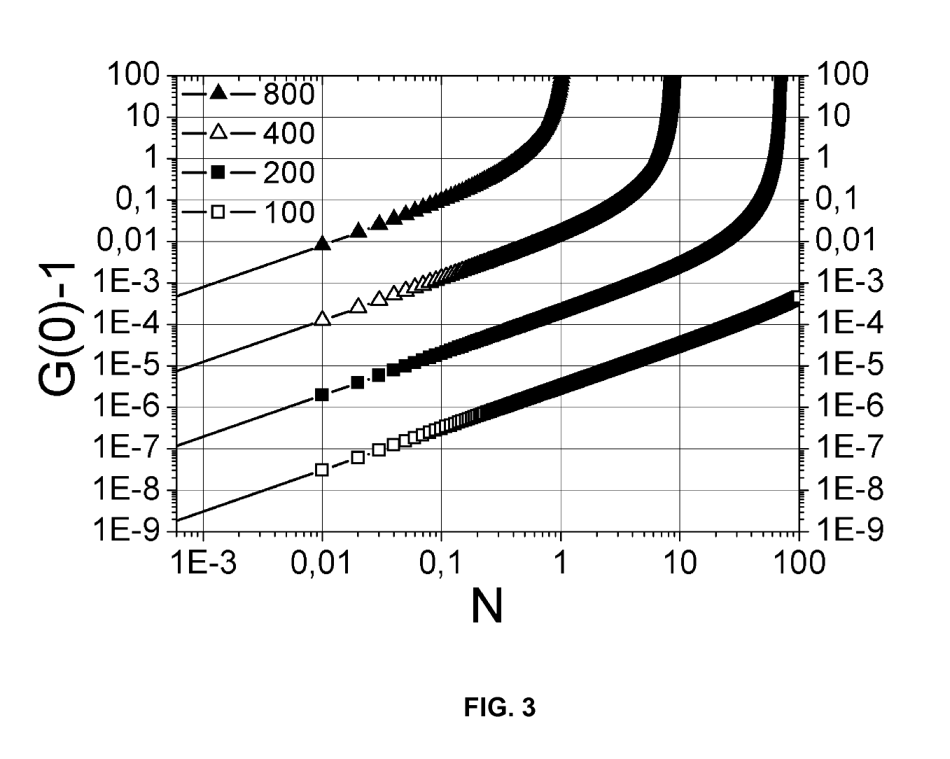

FIG. 3: The Amplitude in iFCS as a Function of the Number of Particles N.

Amplitude, G(0)−1, of the ACF in iFCS as a function of number of particles N, calculated from eq. 3 in example 1 and plotted for 100 (open squares), 200 (filled squares), 400 (open triangles) and 800 nm (filled triangles) beads. For smaller particles the linear relationship between N and G(0) holds for larger values of N compared to what is the case for larger particles.

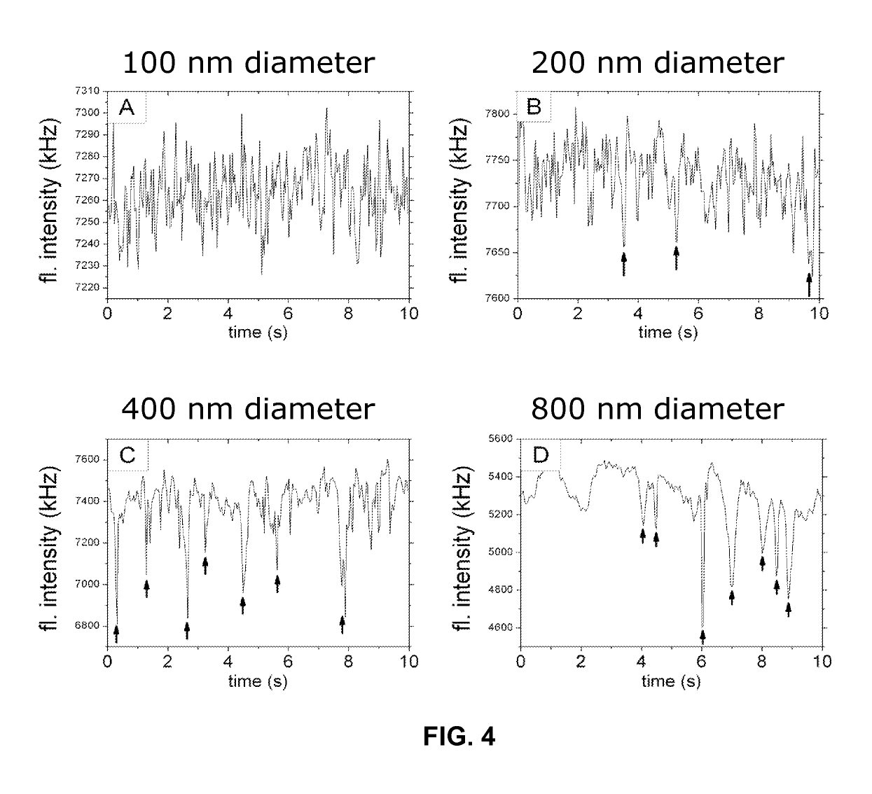

FIG. 4: Intensity Traces from Measurements on Polystyrene Microspheres.

Intensity traces of polystyrene beads in 400 μM alexa 488-medium. a) 100 nm, b) 200 nm, c) 400 nm, d) 800 nm diameter beads. Measurements were performed with 5-7 MHz count rates. Transits of beads through the detection volume result in negative spikes (arrow-marked).

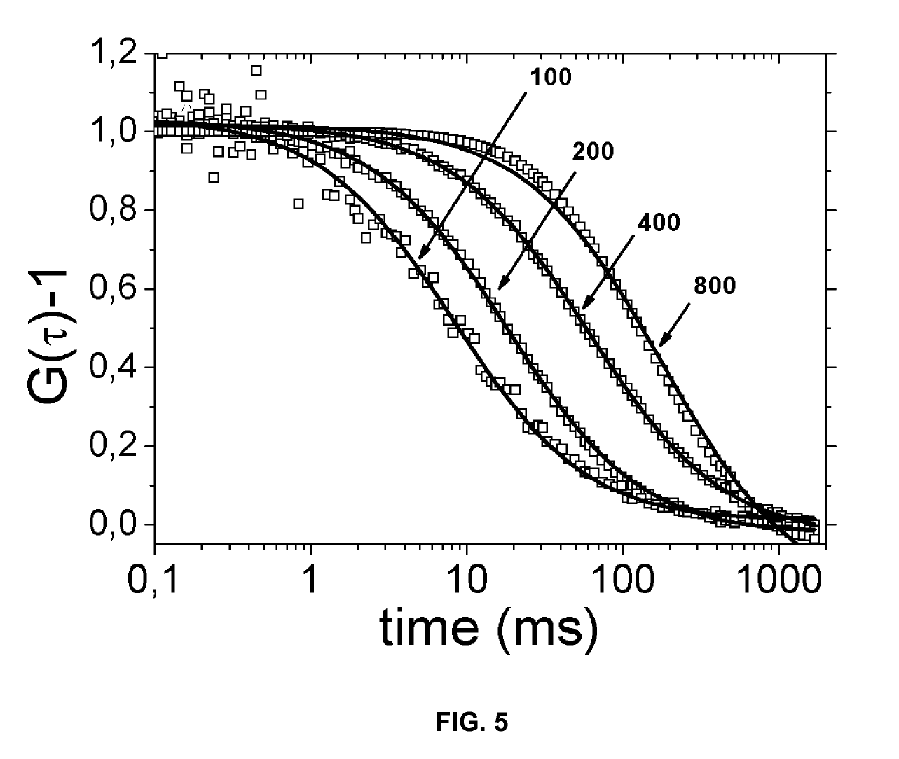

FIG. 5: iFCS-Measurements on Particles of Different Sizes.

Normalized iFCS curves recorded from solutions of 100, 200, 400 and 800 nm diameter beads (marked “100”, “200”, “400”, and “800”) in 400 μM alexa 488. The diffusion times are 8 ms, 20 ms, 60 ms and 160 ms for the 100, 200, 400 and 800 nm beads respectively. All curves have been normalized to 1. Because transits of larger beads reduce the signal more than transits of smaller beads, the signal to noise and therefore the statistics of the ACF curves improve with bead size.

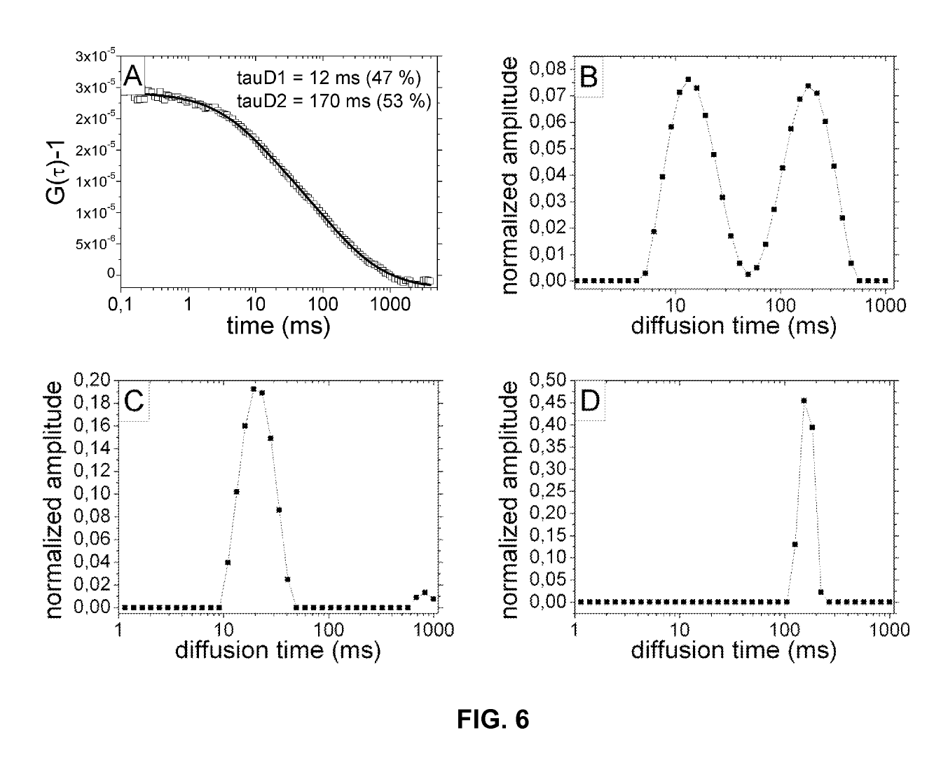

FIG. 6: iFCS-Measurements on a Mixture of Particle-Sizes.

a) iFCS curve recorded from a mixture of 200 nm and 800 nm beads. The curve was fitted to a model including two diffusion components (eq. 1) (solid line), yielding two diffusion times of 12 ms and 170 ms with approximately equal amplitudes. b) CONTIN analysis of the measurement in a). c) CONTIN analysis of a measurement of only 200 nm beads, and d) CONTIN analysis of a measurement of only 800 nm beads.

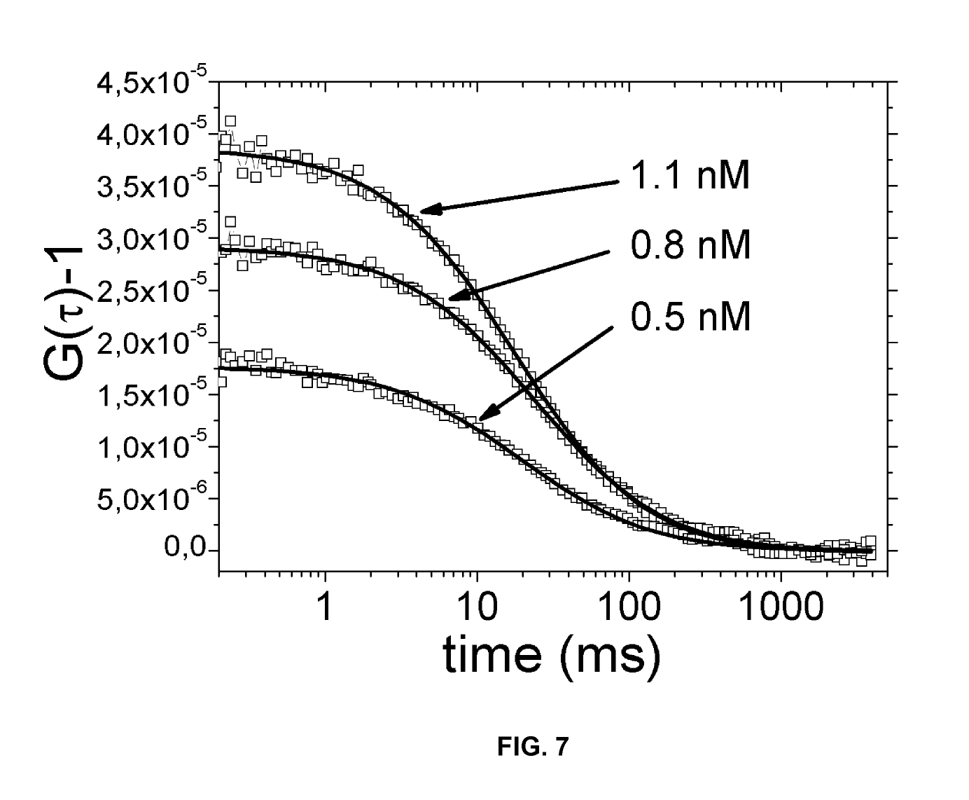

FIG. 7: iFCS Curves Recorded for Three Different Concentrations of 200 nm Beads.

iFCS curves recorded for three different concentrations of 200 nm beads. Using the known bead size of 0.0042 fl, the detection volume of 0.3 fl, and the respective amplitude of the iFCS curves, the number of particles N=0.09, N=0.15 and N=0.19 were obtained using eq. 4, corresponding to the concentrations 0.5 nM, 0.8 nM, and 1.1 nM respectively.

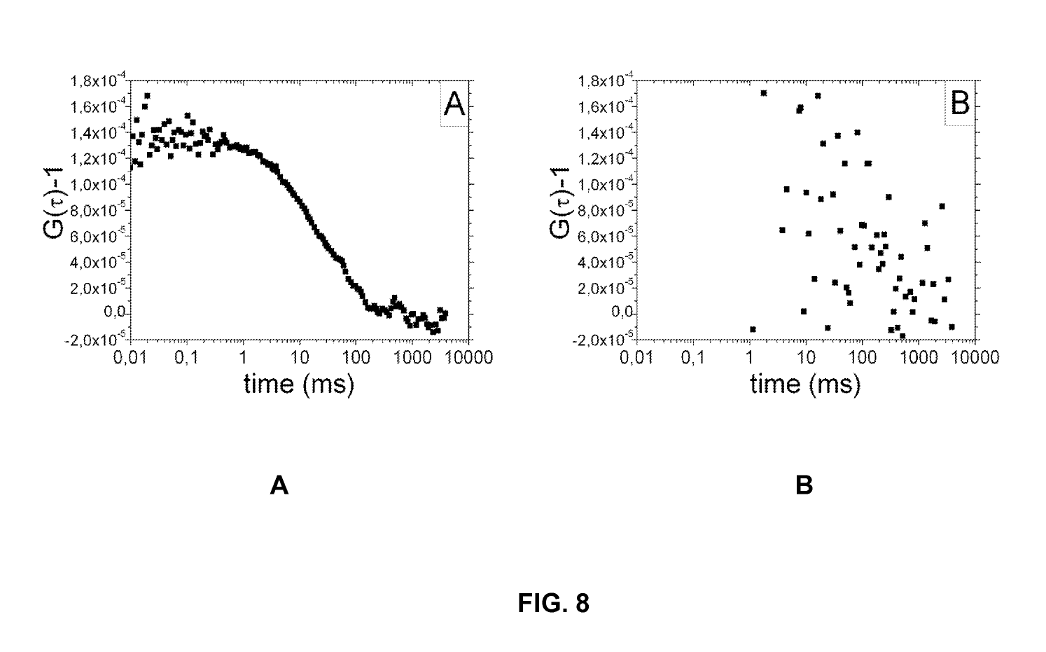

FIG. 8: iFCS is Dependent on the Noise in the Signal from the Medium.

a) iFCS curve from a measurement of 200 nm beads in a medium-concentration of 400 μM alexa 488. (b) iFCS curve from a measurement of 200 nm beads in a medium-concentration of 1 μM alexa 488. The lower medium-concentration in fig (b) results in a larger relative noise in the medium signal, both from molecule fluctuations and photon noise, which blurs the negative contribution from transiting beads. Data were collected for 10 s.

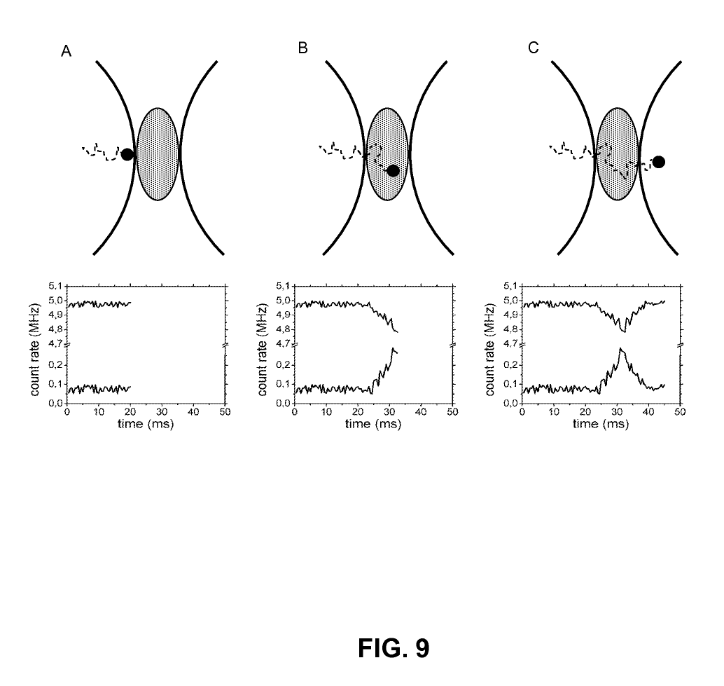

FIG. 9: Cartoon Describing the Principle of Inverse-Fluorescence Cross-Correlation Spectroscopy (iFCCS).

A) Fluorescence is detected simultaneously from the particle-channel (red) and the medium-channel (green), and no particle is present in the detection volume. B) A particle has entered the detection volume, resulting in an increased signal in the red channel and a reduced signal in the green channel. C) The particle has left the detection volume, and both signals are restored. Cross-correlation of the signals from the green and the red channels (iFCCS), resulting in anti-correlation, can give a direct estimate of volume of the analyzed particles/biomolecules, or if the size of the analyzed particles is known, an estimate of the size of the detection volume.

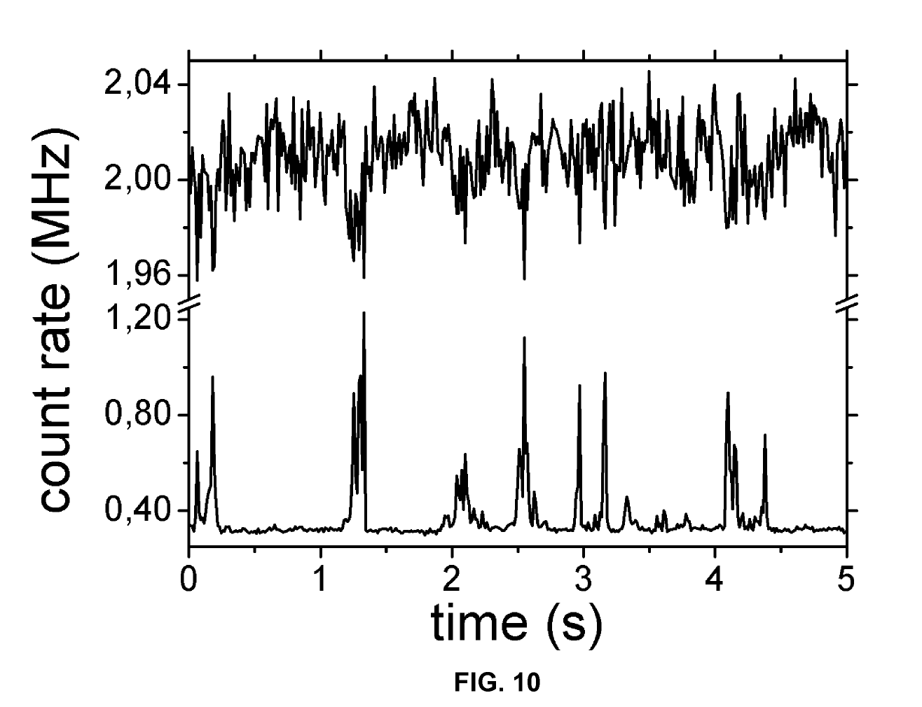

FIG. 10. Example of Experimental Intensity Traces in iFCCS.

Fluorescence intensity traces from 200 nm diameter fluospheres (560 nm emission maximum, lower trace) diffusing through the confocal volume in a solution containing 100 μM alexa 488 (517 nm emission maximum, upper trace). Transiting fluospheres cause negative spikes in the upper trace that coincide with positive spikes in the lower trace.

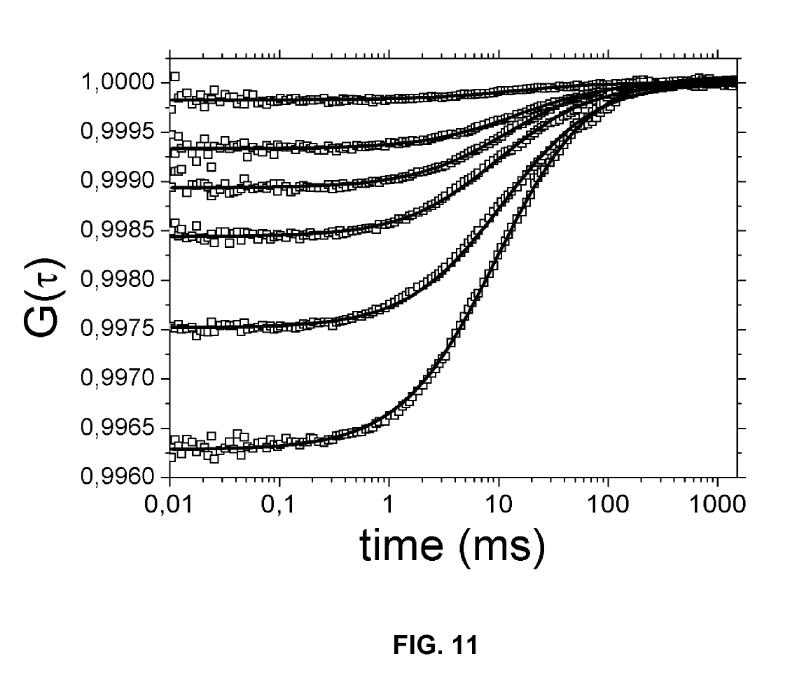

FIG. 11. Example of Experimental iFCCS-Curves.

iFCCS-curves of red fluospheres of 200 nm diameter measured at six different concentrations. The fluospheres were dissolved in a medium containing 100 μM alexa 488. Due to the presence of cross-talk from the green (medium-) channel to the red (fluosphere-) channel, the amplitude of G_{cc}(τ) is dependent on particle concentration. The curves were fitted to a one diffusion component-model allowing the amplitude to be negative.

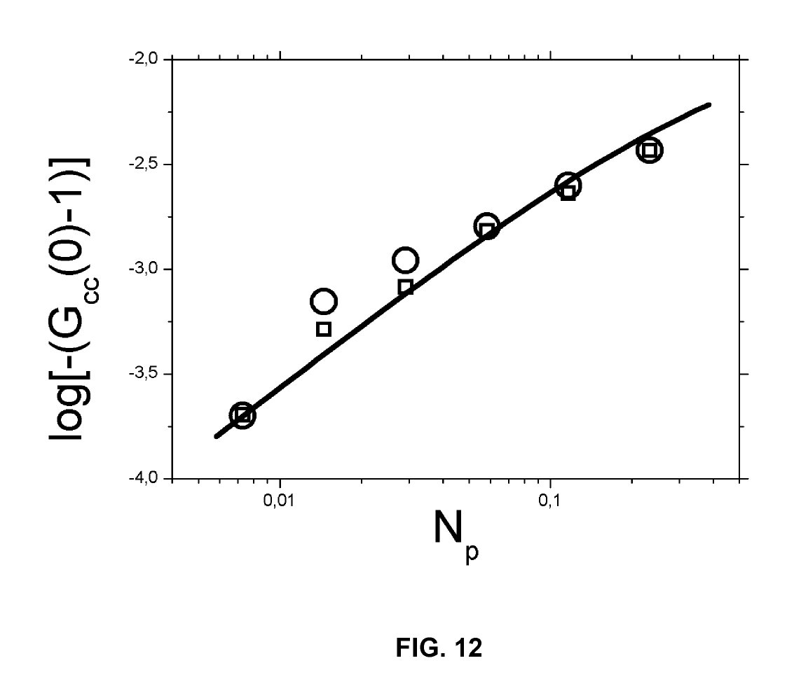

### FIG. 12. Relation Between the Amplitude of G_{cc}(0)−1 and Particle Concentration.

The amplitude of G_{cc}(0)−1 versus the average number of particles in the detection volume Nₚ, from the iFCCS-curves in FIG. 11. The Nₚ-values are taken as dilutions by a factor 2 in each step, from a starting-concentration of Nₚ=0.23 taken from the curve with amplitude ˜0.9963 (lowest curve) in FIG. 11. Black line: Theoretical prediction of G_{cc}(0)−1 from eq. 4 in example 2, where the mean values of Qₚ and I_{ct} from all measurements was used. Open circles: Experimental values of G_{cc}(0)−1 from FIG. 11. Filled squares: Theoretical predictions from eq. 4 in example 2 corrected for Qₚ and I_{ct} which were estimated from the individual measurements.

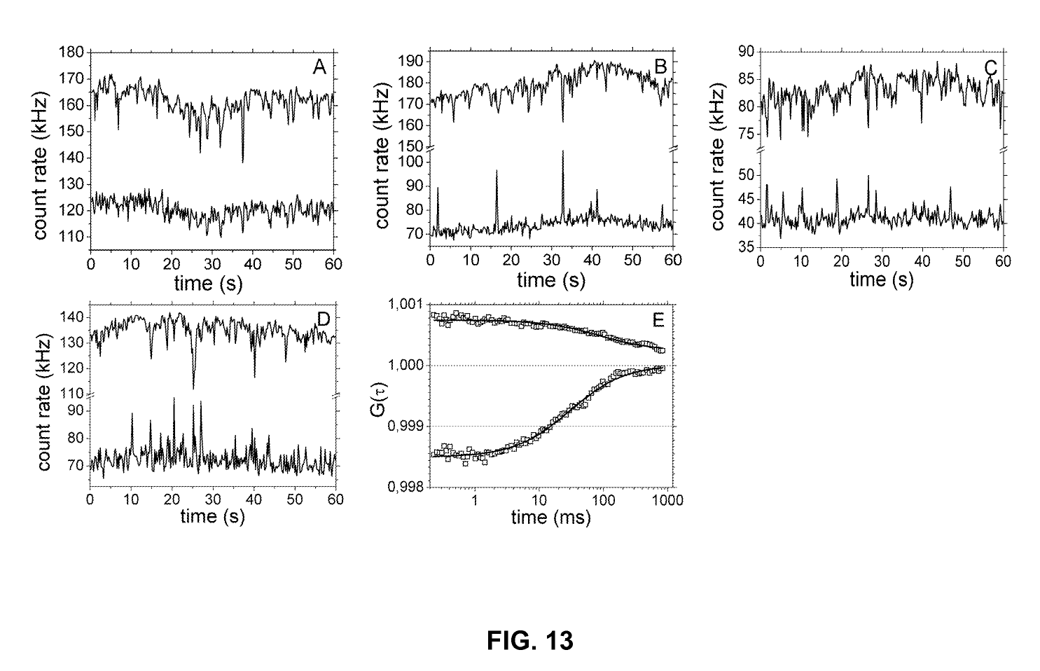

FIG. 13. iFCCS Intensity Traces from Binding of a Biotin-Tagged Fluorophore to Streptavidin-Coated Microspheres.

Binding of biotin-tagged R-Phycoerythrin (RPE-biotin), or of non-tagged RPE, to streptavidin-coated microspheres. A-D shows 60 s intensity traces from both the surrounding medium (upper trace) and from RPE or RPE-biotin (lower trace). A) 60 nM of non-tagged RPE, B) 15 nM of biotin-tagged RPE, C) 30 nM of biotin-tagged RPE, D) 60 nM of biotin-tagged RPE. The fraction of all negative spikes during a 300 s measurement that coincided with a positive spike was for A) 8% (6/74), for B) 30% (27/91), for C) 41% (38/92) and for D) 58% (62/106). E) iFCCS-curves of streptavidin coated spheres in 60 nM RPE (upper curve) and of 60 nM biotin-tagged RPE (lower curve). The lower curve shows anti-correlation, indicating binding between RPE-biotin and spheres. The upper curve shows no anti-correlation, indicating that RPE does not bind to spheres. The upper curve even shows positive correlation as a result of cross-talk from the medium-channel to the RPE-channel (see FIG. 13 A).

### EXEMPLARY EMBODIMENTS

### Exemplary Embodiment 1

### A Fluorescence Correlation Spectroscopy System of the Present Disclosure

Generally, if proteins or other biomolecules are analyzed by iFCS or iFCCS, zero-mode waveguides (ZMWs) can be used in combination with a standard FCS-microscope. The detection volumes in ZMWs are 1000-10 000 times smaller than diffraction-limited detection volumes, which allows proteins and similar sized biomolecules to generate negative spikes of magnitude larger than the noise in the medium-signal. If the FCS-microscope in addition is equipped with alternative photo-detectors that are capable of detecting considerably higher count rates than what APDs are capable of, for example PMTs in DC-mode or photo-diodes, which both give a current as output, then the relative photon-noise in the signal from the medium can be significantly reduced. This in turn allows even smaller proteins and biomolecules to be detected.

### Exemplary Embodiment 2

### Analyzing the Concentration of and Size of Unlabeled Proteins by iFCS

Using iFCS, protein molecules can be analyzed without being fluorescently labeled. iFCS gives an estimate of the concentration and diffusion coefficient of the proteins. The size-estimate of particles/proteins possible from iFCS is the same as in standard FCS in that the size is estimated from the diffusion coefficient. This is in contrast to iFCCS, which allows a direct estimate of the volume of particles/proteins. However, by using FIDA/PCH (Chen et al., 1999; Kask et al., 1999) as described above, the volume of particles/proteins can be estimated in iFCS, i.e. also for unlabeled particles/proteins.

An experiment can be carried out as follows:

The protein-sample is dissolved in the signal-generating medium (for example 1 mM alexa 488 carboxylic acid dissolved in a buffer of pH 8.5), and analyzed in the detection volume created by the ZMW on the iFCS-microscope. The automatically generated autocorrelation-curve (“iFCS-curve”) is fitted to an appropriate theoretical model for translational diffusion. The diffusion time τ_{D} gives an estimate of the size of the protein molecules. However, a better estimate of the protein molecules' size can be obtained by using FIDA-/PCH-based analysis (Chen et al., 1999; Kask et al., 1999) of the medium-signal, because FIDA/PCH can give an estimate of the depth of the negative spikes, which is a direct measure of the volume of the analyzed protein molecules. Once the volume of the protein molecules is estimated, the concentration of proteins is given from the amplitude of the iFCS-curve.

If a reaction between protein molecules is occurring over time, for example binding between the same or different types of protein molecules, or aggregation between protein molecules, then consecutive measurements, for example 30s long, can be performed in order to follow the reaction over time. For example, if the protein molecules of the same type form pairs over time (dimerization), the fraction of the larger component in the theoretical iFCS-model—given from analyzing the iFCS-curves using the FIDA/PCH-approach—would increase over time.

### Exemplary Embodiment 3

### Analyzing the Binding of a Labeled Protein to an Unlabeled Protein by iFCCS

In standard FCS, the binding of a labeled biomolecule to an unlabeled one can be detected only if the resulting complex has a diffusion time at least 1.6 times longer than the unbound labeled protein (Meseth et al., 1999). For spherical molecules, this corresponds to a volume at least ˜4 times that of the unbound labeled protein. iFCCS is more sensitive and should allow identification of complexes whose size differs less from that of unbound labeled proteins; with the ability to identify complexes with a volume 1.6 times larger than that of unbound labeled proteins, complexes can be 2.5 times smaller than the resolution-limit in standard FCS and still be identified by iFCCS

An experiment can be carried out as follows:

Fluorescently labeled protein-molecules, e.g. a labeled antibody (protein A), is mixed with another, unlabeled protein (protein B), whose volume can be smaller or larger than that of the labeled antibody, but must be at least 60 of that of the antibody. iFCCS-measurements are performed using the ZMW positioned onto the iFCS-microscope. Consecutive measurements, for example 30s each, are performed in order to follow the interaction of the two proteins over time. The concentration of complexes (AB) increases over time, which is monitored as a development of the iFCCS-curve over time: Fits of the iFCCS-curves to a theoretical model assuming two molecular species reveal that the concentration of AB increases over time.

In addition, the total number of molecules (labeled and unlabeled) can be estimated from iFCS, i.e. from autocorrelation of the medium-signal alone. Thus the concentrations of all three species A, B and AB can be measured, from which the equilibrium dissociation constant K_{D} can be estimated. This is a unique feature for iFCCS, not possible in standard FCS, only from standard FCCS which requires labeling of both binding partners.

### Exemplary Embodiment 4

### Analyzing the Binding of a Small, Fluorescently Labeled Ligand to an Unlabeled Protein by iFCCS

Exemplary embodiment 3 described analysis of two different proteins, one fluorescently labeled and the other unlabeled, whose volumes were both sufficient to result in negative spikes in the medium-signal upon transit through the detection volume. In contrast, the example given here describes analysis by iFCCS of fluorescently labeled ligands that are too small to generate detectable negative spikes in the medium-signal, and the interaction of such ligands with unlabeled protein molecules of sufficient size to generate negative spikes in the medium-signal.

An experiment would be carried out as follows:

Labeled ligands and unlabeled proteins are mixed. iFCCS-measurements are performed using the ZMW positioned onto the iFCS-microscope. Consecutive measurements, for example 30s each, are performed in order to follow the interaction of ligands and protein molecules over time. A protein carrying at least one labeled ligand will upon transit through the detection volume give rise to a negative spike in the medium-channel that coincides with a positive spike in the ligand-channel. As a result, cross-correlation analysis will show that the signals are anti-correlated. As more and more of the protein molecules carry labeled ligands, the amplitude of the iFCCS-curve will become more and more negative, and give estimates of the concentration of ligand-carrying proteins for each measurement.

As in the example above, the total concentration of proteins (labeled and unlabeled), can be measured separately by iFCS, from autocorrelation of the medium-signal. Therefore, by comparing the concentration of ligand-carrying protein molecules estimated by iFCCS, with the total number of protein molecules estimated by iFCS, a direct estimate of the fraction of all proteins that carry a ligand can be estimated. The concentration of ligands can be measured by standard FCS, and hence all three species—ligands, proteins not carrying a ligand, and proteins carrying a ligand—can be estimated. As in the iFCCS-example above, this allows the equilibrium dissociation constant K_{D} between ligands and proteins to be estimated.

### EXPERIMENTAL EXAMPLES

The following non-limiting experimental examples will further illustrate the present invention.

### Experimental Example 1

### Inverse Fluorescence Correlation Spectroscopy (iFCS)

The concept of inverse-FCS has been proven by using a medium consisting of the fluorophore alexa 488 at high concentration (400 μM). Particles of 800, 400, 200 and 100 nm diameter could be analyzed. The theoretical expression for the amplitude of the autocorrelation function (ACF) was derived and used to obtain the concentration of particles from an iFCS measurement of 200 nm beads at different concentrations. It was shown that in iFCS, the amplitude of the ACF is proportional to the particle concentration in the sample, i.e. opposite to the situation of standard FCS where the amplitude of the ACF is inversely proportional to the particle concentration. Furthermore, an iFCS measurement was performed on a sample containing both 200- and 800 nm beads, where the two particle sizes could be estimated. This example of iFCS will now be described in more detail.

The 488 nm emission from an Argon ion laser (Melles Griot) was reflected into a water immersion objective (63×, 1.2 NA, Zeiss) by a dicroic mirror (488 LP, Chroma) and focused into the sample (focal plane radius ω=0.22 μm, and size of the confocal detection volume V_{dv}=0.3 fl). Fluorescence emission was collected by the same objective, spectrally and spatially (pinhole diameter 30 μm) filtered and then collected by two avalanche photo diodes (SPCM-AQR-14, Perkin Elmer). The autocorrelation of the signal was generated by a correlator board (ALV6000, ALV GmbH, Germany).

Alexa 488 carboxylic acid (Invitrogen) in aqueous solution was used as medium with 0.5% Triton X-100 (Sigma Aldrich). Carboxyl modified beads (IDC-latex/Invitrogen) were mixed with detergent and bath sonicated in glass vials for 30-60 min before use. For analysis of diffusion time-distribution the CONTIN algorithm was used (Provencher, 1982). All measurements were performed on a home built FCS setup (Rigler et al., 1993).

In FCS, the normalized autocorrelation function (ACF) of the detected fluorescence intensity (eq 1) yields values of the average number of molecules in the detection volume, N, of the characteristic diffusion time, τ_{D}, and in applicable cases of fluctuations between high-/low-fluorescent states of the fluorophore. For the case where translational diffusion of the molecules is the only process generating fluorescence fluctuations, the ACF is given by

$$\begin{matrix}G ( τ ) = \frac{〈 I ( t ) \cdot I ( t + τ ) 〉}{{〈 I ( t ) 〉}^{2}} \\ = \frac{〈 δ I ( t ) \cdot δ I ( t + τ ) 〉}{{〈 I ( t ) 〉}^{2}} + 1 \\ = \frac{1}{N} {\sum }_{i = 1}^{n} \frac{{a}_{i}}{1 + \frac{τ}{{τ}_{{D}_{i}}}} \frac{1}{\sqrt{1 + \frac{τ}{{τ}_{{D}_{i}}} \frac{{ω}_{0}^{2}}{{z}_{0}^{2}}}} + 1\end{matrix} \qquad ( 1 )$$

Here I is the detected fluorescence intensity, δI is the deviation from the mean intensity at a certain time point, (δI(τ)=I(τ)− [symbol] I [symbol] ), and brackets denote mean value. The model includes n different diffusion species, with corresponding amplitudes aᵢ and characteristic diffusion times τ_{Di}. ω₀ and z₀ denote the distances in the radial and axial dimensions respectively, at which the average detected fluorescence intensity has dropped to e⁻² of its peak value.

For inverse-FCS (iFCS) as well as standard FCS, the amplitude of the ACF follows from eq. 1 by insertion of τ=0:

$$G ( 0 ) - 1 = \frac{〈 δ {I ( 0 )}^{2} 〉}{{〈 I 〉}^{2}} . \qquad ( 2 )$$

If a decrease in particle concentration is measured using standard FCS, the denominator in eq. 2 will decrease proportionally to the square of the concentration. However measurement of a decrease in particle concentration using iFCS—where the intensity is generated by the medium and not by the particles—will for moderate particle concentrations leave the denominator in eq. 2 essentially unchanged. The numerator in eq. 2 is proportional to the particle concentration for both iFCS and standard FCS, since the variance equals N for Poisson processes. Taken together, the particle concentration in iFCS is proportional to the amplitude of the ACF, rather than being proportional to the inverse amplitude of the ACF as is the case for standard FCS.

Insertion into eq 2 of the following parameters: V_{q}=Vₚₐᵣₜ/V_{dv} where Vₚₐᵣₜ is the volume of a particle and V_{dv} is the size of the detection volume, the total fluorescence intensity from the medium in the detection volume when no particles are present I_{dv}, and the average number of particles N, gives

$$G ( 0 ) - 1 = \frac{{( \sqrt{N} \cdot {V}_{q} \cdot {I}_{dv} )}^{2}}{{( {I}_{dv} - N \cdot {V}_{q} \cdot {I}_{dv} )}^{2}} = \frac{N}{{( \frac{1}{{V}_{q}} - N )}^{2}} . \qquad ( 3 )$$

The standard deviation of N equals δN=\sqrt{N} because N is Poisson distributed. Multiplying \sqrt{N} with V_{q}·I_{dv} gives to the reduction in total fluorescence signal due to the presence of particles in the detection volume (eq. 3).

From eq. 3 follows that the ACF-amplitude is determined not only by N, but by V_{c}, as well. Thus in order to deduce the concentration of particles from the ACF, V_{q}=Vₚₐᵣₜ/V_{d}, must be known. V_{dv} can readily be obtained from standard FCS by measuring the diffusion time of a fluorophore with known diffusion coefficient, using the same instrument as for iFCS. Vₚₐᵣₜ can be estimated from the diffusion time τ_{D,part} obtained from iFCS, assuming on average spherically shaped particles. For estimation of V_{dv} we used alexa 488 with a diffusion coefficient D=390 μm²/s (414 μm²/s from (Petrasek and Schwille, 2008) and corrected for our room temperature of 22° C.), which with a measured diffusion time of 31 μs gives V_{dv}=0.30 fl.

From eq 3 further follows that there is an approximately linear relationship between G(0)−1 and particle concentration as long as the combined volume of all particles in the detection volume is less than ˜20% of the detection volume (FIG. 3).

Solving eq. 3 for N gives

$$N = \frac{\frac{1}{G ( 0 ) - 1} + \frac{2}{{V}_{q}}}{2} \pm \sqrt{{( \frac{\frac{1}{G ( 0 ) - 1} + \frac{2}{{V}_{q}}}{2} )}^{2} - \frac{1}{{V}_{q}^{2}}} , \qquad ( 4 )$$

where the minus sign gives relevant N-values. Thus, in iFCS the ACF is fitted to the same models as used for standard FCS (eq 1), but with the amplitude 1/N replaced by the expression in eq 3.

To experimentally verify the iFCS concept, measurements were performed on spherical polystyrene beads with diameters 100, 200, 400 and 800 nm. In the iFCS measurements, the fluorescence signal from the medium of 400 μM aqueous solution of alexa 488 was transiently reduced upon passage of traversing beads. The reduction appeared as negative spikes in the intensity traces for the 200, 400 and 800 nm beads (arrow marked in FIG. 4 b-d).

As expected, the diffusion time τ_{D,part} increases with particle size for the measured beads (FIG. 5). However, while τ_{D,part} increases linearly with particle radius for point like particles, τ_{D,part} can be expected to increase more than linearly for particles with radius rₚₐᵣₜ exceeding ˜20% of the beam radius ω₀ (Starchev et al., 1998; Wu et al., 2008). Under our conditions, Vₚₐᵣₜ will thus be overestimated unless this effect is taken into account. Considering this effect, and comparing with the measured value of τ_{D,part}=8 ms for the 100 nm beads, the 200 and 400 nm beads are expected to have τ_{D,part}=18 ms and τ_{D,part}=55 ms respectively according to Starchev et al (Starchev et al., 1998), and 21 ms and 73 ms respectively according to Wu et al (Wu et al., 2008). The predictions of these two references differ slightly, however our measured values of τ_{D,part}=20 ms for the 200 nm beads and τ_{D,part}=60 ms for the 400 nm beads agree fairly well with both predictions (FIG. 5). Accordingly, the same particle size effect that has been predicted and observed in FCS measurements also appear in iFCS, and must be accounted for. In the references (Starchev et al., 1998; Wu et al., 2008) the formulas are invalid when rₚₐᵣₜω₀>1.2 wherefore no valid prediction could be calculated for the 800 nm beads.

The ability of iFCS to resolve different particle sizes was tested by measuring a mixture of 200 nm beads and 800 nm beads (FIG. 6 a-d). As expected a satisfactory fit of the ACF required a model with two diffusion components (n=2 in eq. 1) (FIG. 6a). The same measurement was also analyzed with the CONTIN algorithm (Provencher, 1982), which resulted in two distinct particle size distributions (FIG. 6b). The diffusion time of 12 ms for the 200 nm beads in the mixture deviates somewhat from the 20 ms estimate from the measurements on pure 200 nm beads (FIG. 6c). A likely explanation for this is the low concentration of 800 nm beads used in the mixture, about 20 μM, which limits the statistics.

The particle concentration dependence in iFCS measurements were investigated for 200 nm beads at different concentrations (FIG. 7). As predicted by eq. 3, the amplitude of the ACF increases with higher particle concentrations. For 200 nm beads, Vₚₐᵣₜ=0.0042 fl, and using V_{dv}=0.3 fl gives V_{q}=Vₚₐᵣₜ/V_{dv}≈0.014. Insertion of V_{q} together with the amplitude 1.8·10⁻⁵ (FIG. 7) into eq 3 gives N=0.09 for the curve with the lowest amplitude, equaling a particle concentration, Cₚ, of 0.5 nM. Similarly, insertion of the amplitudes 2.9·10⁻⁵ and 3.8·10⁻⁵ (FIG. 7) together with the value for V_{q} gives N=0.15 and N=0.19 respectively, corresponding to Cₚ=0.8 nM and Cₚ=1.1 nM respectively. The two curves with lower amplitude were measured at 1.5× and 2× dilutions from the sample giving the highest amplitude. Thus, as expected the amplitude increases linearly with particle concentration (FIG. 3).

How small particles that can be analyzed by iFCS is determined by the ratio between V_{q}=Vₚₐᵣₜ/V_{dv} and the relative noise in the medium-signal. Thus the sensitivity can be improved by either reducing the noise or decreasing the detection volume.

The noise in turn is determined by 1) fluctuations in the number of detected photons per time bin, n_{ph/bin}, and 2) fluctuations in the number of medium-molecules that generate the signal collected during one time bin, n_{dyes/bin}. Both n_{ph/bin} and n_{dyes/bin} depend linearly on the bin time t_{bin}, and because they both are poisson-distributed, their standard deviations equal their square roots. Their corresponding relative noise levels, defined as the standard deviation of the signal divided by the signal itself, therefore equal

$$\begin{matrix}{Rn}_{ph} = \frac{1}{\sqrt{{n}_{ph / bin}}} \\ and & ( 5 ) \\ {Rn}_{dye} = \frac{1}{\sqrt{{n}_{dyes / bin}}} . & ( 6 )\end{matrix}$$

The linear dependence on t_{bin} implies that shorter t_{bin} results in larger values of Rnₚₕ and Rn_{dye} (eq. 5 and 6). How short t_{bin} that is required depends on the diffusion time τ_{D,part} to be resolved. On-line correlator boards are often used which calculate the ACF continuously using multiple bin times. However, for the estimations performed here we define for convenience a single bin time for each iFCS measurement, and the bin time necessary for a certain iFCS measurement to be one tenth of τ_{D,part}. For the 100 nm beads the diffusion time τ_{D,part} was 8 ms (FIG. 5), so t_{bin}=0.8 ms. The count rate of 5 MHz thus gives a relative photon noise of Rnₚₕ=0.016.

For the molecular noise, n_{dyes/bin} is larger than the average number of medium-molecules N_{dye} in the detection volume, since t_{bin}>τ_{D,dye}. An estimation of n_{dyes/bin} is given by N_{dye}·t_{bin}/τ_{D,dye}. In our experiment, the medium concentration of 400 μM corresponds to N_{dye}=72 000.With t_{bin}=0.8 ms for the 100 nm beads, and τ_{D,dye}=31 μs, it follows that n_{dyes/bin}=1.9·10⁶. Thus Rn_{dye}=7.3·10⁻⁴ (eq 7), which is about 20 times smaller than the Rnₚₕ estimated above. Accordingly, fluctuations in n_{dyes/bin} contribute negligibly to the overall level of noise in our measurements.

With photon noise being the dominating source of noise, it follows that iFCS measurements with large Rnₒ, require a large V_{q}=Vₚₐᵣₜ/V_{dv} (FIG. 2). In our setup, the 100 nm diameter beads were the smallest particles that could be analyzed. The ratio V_{q}/Rnₚₕ for the 100 nm beads thus gives an estimate of the lower limit of this ratio (FIG. 2c). For the 100 nm beads V_{q}=Vₚₐᵣₜ/V_{dv}=5.25·10⁻⁴ fl/0.3 fl=0.00175. Dividing this value by Rnₚₕ=0.016 gives 0.11, indicating that a Rnₚₕ up to ˜9 times larger than V_{q} still yields acceptable noise levels.

For particle sizes where rₚₐᵣₜ>ω₀, the ratio V_{q}=Vₚₐᵣₜ/V_{dv} may approach or even exceed unity. The medium-signal during a particle-transit will however not be reduced to the same extent because only a fraction of the detection volume will be occupied by a particle during its transit. Accordingly the ACF-amplitude for such particles will be smaller than estimated from eq. 3. Since the actual size of the particles is revealed by the diffusion time, true concentrations will still be obtainable for particles with rₚₐᵣₜ>ω₀, however derivation of such expressions are beyond the scope of this Letter.

To confirm that the fluorescence fluctuations did not originate from positive signals from beads with unspecifically bound fluorophores, measurements were performed at lower medium concentrations. Since iFCS is dependent on a low noise in the medium signal, lowering the medium concentration and thus increasing both Rnₚₕ and Rn_{dye} should make the iFCS curves noisier. This was also observed (FIG. 8). A further confirmation that the iFCS curves were generated by transient reductions in medium signal was the direct observation of negative spikes in the intensity traces (FIG. 4), rather than the observation of positive spikes which would be the result of beads with unspecifically bound fluorophores.

Several possible improvements of the iFCS approach can be foreseen. The sensitivity can be increased by reducing Rnₚₕ and/or by increasing V_{q}. The Rnₚₕ-level can be reduced by introducing photomultiplier tubes fed with low voltages, capable of detecting photon fluxes several orders of magnitude higher than those detectable by APDs. V_{dv} can be reduced by several orders of magnitude, e.g. by use of STED-microscopy (Hell, 2003; Kastrup et al., 2005), or so called Zero Mode Wave Guides (Foquet et al., 2008).

The inverted fluorescence fluctuations can also be analyzed by other means than by the ACF. Intensity distribution analyses like Photon Counting Histogram (PCH) and Fluorescence Intensity Distribution Analysis (FIDA) (Chen et al., 1999; Kask et al., 1999) are likely well suited complementary approaches, since the “signal strength” is directly related to particle size.

An interesting possibility is the use of smaller medium molecules that could be present at higher concentrations than fluorescent dye molecules. The higher concentration could enable a stronger medium-signal, which as mentioned earlier will enhance the sensitivity of iFCS. Concentrations of that of water, 55 M, may be possible, and a signal could be generated by e.g. resonance raman scattering. Example of small molecules that generate strong signals using resonance raman- or preresonance raman scattering are carbon disulfide and isoprene. In addition to the possibility of generating a stronger medium-signal, the use of resonance raman excitation in the UV will create a smaller detection volume which will enhance the sensitivity of iFCS further. Moreover, higher medium-concentrations will result in a molecular noise from the medium that is even less significant, thus enabling analysis of even smaller particles/biomolecules. Finally unspecific binding of the small medium-molecules to the analyzed particles/particles will likely be less prominent than that of organic dye molecules.

iFCS could also be combined with standard FCS for simultaneous analysis of labeled and unlabeled particles or biomolecules. Thereby, new modes of cross-correlation can be exploited, analyzing e.g. the binding of a small dye-labeled ligand to a larger unlabeled particle.

The diffusion time of particles is dependent on their size but also on their shape. In contrast, the amplitude of the ACF is affected only by the particle size, not by particle shape. Thus an intriguing possibility would be to analyze the shape of particles using iFCS. If the particle concentration is known, the shape of the particles could be analyzed by comparing the ACF amplitude with τ_{D,part}.

In summary, iFCS allows analysis of particle size and concentrations without fluorescence labeling of particles. In the experiments presented here, with a diffraction limited detection volume of 0.3 fl, and photon count rates of 5-7 MHz using avalanche photo diodes, the lower limit for particle sizes that can be analyzed is ˜100 nm diameter. Reduction of detection volumes and/or finding of applicable detectors capable of higher count rates will enable analysis of smaller particles. The approach can be combined with standard FCS and other established fluorescence fluctuation techniques such as PCH/FIDA.

### Experimental Example 2

### Inverse Fluorescence Cross-Correlation Spectroscopy (iFCCS)

### Theory

The principle of Inverse Fluorescence Cross-correlation Spectroscopy (iFCCS) is seen in FIG. 9. The theory of FCS (Elson, 1974; Magde et al., 1972) and of FCCS (Schwille et al., 1997) has been described previously. In inverse-FCS, the dependence of the autocorrelation function and of the cross-correlation function on particle mobility is the same as for standard FCS. The particle concentration dependence however is different in iFCS as well as in iFCCS: The cross-correlation function is defined as

$${G}_{cc} ( τ ) = \frac{〈 {I}_{g} ( t ) \cdot {I}_{r} ( t + τ ) 〉}{〈 {I}_{g} 〉 \cdot 〈 {I}_{r} 〉} \qquad ( 1 )$$

from which the amplitude is given as

$${G}_{cc} ( 0 ) - 1 = \frac{〈 δ {I}_{g} ( 0 ) \cdot δ {I}_{r} ( 0 ) 〉}{〈 {I}_{g} 〉 \cdot 〈 {I}_{r} 〉} \qquad ( 2 )$$

In iFCCS, the detected fluorescence intensity is I_{g}=I_{g,tot}·(1−N_{pg}·V_{qg}) for the green channel and Iᵣ=Qₚ·Nₚᵣ×(I_{ct}=I_{ligand})·(1−Nₚᵣ·V_{qr}) for the red channel in an iFCCS-measurement using green medium-molecules and red-labeled ligands. Here I_{g,tot} is the average fluorescence intensity from the medium when the detection volume is void of particles, N_{pg} and Nₚᵣ are the average number of particles in the green and the red detection volumes respectively,

$${V}_{qg} = \frac{{V}_{part}}{{V}_{g}} and {V}_{qr} = \frac{{V}_{part}}{{V}_{r}}$$

where Vₚₐᵣₜ is the volume of a particle and V_{g} and Vᵣ are the sizes of the green and the red detection volumes respectively, Qₚ is the fluorescence intensity per particle (red channel), I_{ct} is the intensity in the red channel originating from cross-talk from green fluorescence, and I_{ligand} is the total intensity from unbound ligands in the red detection volume Vᵣ. Furthermore

$${N}_{pr} = {N}_{pg} \cdot \frac{{V}_{r}}{{V}_{g}} and {V}_{qr} = {V}_{qg} \cdot \frac{{V}_{g}}{{V}_{r}} .$$

The above expressions together with eq. 2 give at hand that the particle concentration dependence is given by

$${G}_{cc} ( 0 ) - 1 = \frac{- [ {Q}_{p} - ( {I}_{ct} + {I}_{ligand} ) \cdot {V}_{qg} \cdot \frac{{V}_{g}}{{V}_{r}} ] \cdot {N}_{pg} \cdot {V}_{qg} \cdot \sqrt{\frac{{V}_{r}}{{V}_{g}}}}{( {I}_{ct} + {I}_{ligand} ) \cdot {( 1 - {N}_{pg} \cdot {V}_{qg} )}^{2} + {N}_{pg} \cdot {Q}_{p} \cdot \frac{{V}_{r}}{{V}_{g}} ( 1 - {N}_{pg} \cdot {V}_{qg} )} . \qquad ( 3 )$$

V_{qg} can be estimated from standard FCS by measuring a dye with known diffusion coefficient, using the same instrument as for iFCCS (or as will be shown below, by measuring iFCCS on fluospheres of known size). The cross-talk CT, defined as the fraction of the total count rate in the green channel that is detected in the red channel, can be determined independently from the emission spectrum of the green dye used for the medium, together with the emission filter-set for green and the red channels. Thus I_{ct}=I_{g}·CT, where I_{g} is the total count rate detected in the green channel. I_{ligand} and Qₚ can be estimated by first determining Q_{ligand} and the diffusion time τ_{D,ligand} from a separate, independent standard FCS-measurement, and using these estimations in a subsequent measurement of ligands and ligand-binding particles with standard FCS.

### Materials and Methods

All measurements were performed on a Zeiss Confocor 2. For the measurements on fluospheres, simultaneous excitation using 458 nm and 543 nm was used. For the binding-measurements only 488 nm excitation was used. The 200 nm fluospheres (540/560 carboxylate modified fluospheres, Invitrogen) were measured in 20 mM Tris, 75 mM KCl, pH 8.6, containing 100 μM alexa 488 carboxylic acid (Invitrogen) and 0.025% Triton X-100. The streptavidin coated polystyrene microspheres (320 nm diameter, Bangs Laboratories) were dissolved in the same buffer as described above, but containing 2.5 μM alexa 488 carboxylic acid and 0.13% Triton X-100. R-Phycoerythrin-biotin and R-Phycoerythrin (both from Invitrogen), both with emission maximum at 575 nm, were used as ligand and control respectively. Emission filter BP475-525 for the alexa 488-emission, and BP585-615 for the fluosphere-emission was used. For the binding-measurements emission filter BP505-530 were used for the alexa 488 emission, and BP560-615 for the RPE-emission.

### Results and Discussion

To verify the concept of iFCCS, measurements were performed on fluorescently labeled (emission maximum 560 nm) polystyrene beads of 200 nm diameter, in a buffer containing 100 μM alexa 488 (emission maximum 517 nm). The transit of a bead through the detection volume generates simultaneously a negative spike in the green channel and a positive spike in the red channel (FIG. 10).

Cross-correlation curves were measured for six different concentrations of the 200 nm fluospheres. As expected, the curves display anti-correlation between the two detection channels, and the amplitude of the curves, G_{cc}(0)−1, becomes more negative with increasing particle concentration (FIG. 11).

The experimentally obtained values of G_{cc}(τ)−1 agree with the predictions from eq. 4 (FIG. 12). The slight deviations from the prediction of eq. 4 are mainly caused by variations in particle brightness Qₚ between different measurements and by variations in cross-talk I_{ct}. Especially for measurements at low particle concentrations Qₚ will vary between measurements, due to the low number of transiting events per measurement, which causes variations in G_{cc}(0)−1.

The dependence of G_{cc}(0)−1 on particle concentration is a result of cross-talk between the green and the red detection channels (I_{ct}), and/or the presence of free ligands (I_{ligand}, see eq. 3). In the measurements on fluospheres, no free ligands were present (I_{ligand}=0 in eq. 3), and for such a situation eq. 3 reduces to

$${G}_{cc} ( 0 ) - 1 = \frac{- [ {Q}_{p} - {I}_{ct} \cdot {V}_{qg} \cdot \frac{{V}_{g}}{{V}_{r}} ] \cdot {N}_{pg} \cdot {V}_{qg} \cdot \sqrt{\frac{{V}_{r}}{{V}_{g}}}}{{I}_{ct} \cdot {( 1 - {N}_{pg} \cdot {V}_{qg} )}^{2} + {N}_{pg} \cdot {Q}_{p} \cdot \frac{{V}_{r}}{{V}_{g}} ( 1 - {N}_{pg} \cdot {V}_{qg} )} . \qquad ( 4 )$$

Since eq. 4 takes into account cross-talk (I_{ct}), it is still dependent on N_{pg}. In the case of both I_{ligand}=0 and I_{ct}=0 however, eq. 4 reduces to

$${G}_{cc} ( 0 ) - 1 = \frac{- {V}_{qg} \sqrt{\frac{{V}_{g}}{{V}_{r}}}}{( 1 - {N}_{pg} \cdot {V}_{qg} )} . \qquad ( 5 )$$

The factor

$$\sqrt{\frac{{V}_{g}}{{V}_{r}}}$$

is needed to give an estimate of the size-ratio between the green and the red detection volumes. Eq. 5 is roughly constant and equals

$$- {V}_{qg} \sqrt{\frac{{V}_{g}}{{V}_{r}}}$$

up to N_{pg}≈1 if, as an example, 200 nm fluospheres in a diffraction-limited detection volume would be used. For smaller particles eq. 5 remains approximately constant and equals

$$- {V}_{qg} \sqrt{\frac{{V}_{g}}{{V}_{r}}}$$

for even higher particle concentrations.

From eq. 5 follows that an iFCCS-measurement of fluorescent spheres of known size where the cross-talk is zero and where (1−N_{pg}·V_{qg})≈1 will give an estimate of

$$- {V}_{qg} \sqrt{\frac{{V}_{g}}{{V}_{r}}} .$$

Hence, if the size of the fluorescent spheres is known in our iFCCS measurements, an estimate of V_{g} is obtained. The standard procedure for calibrating the FCS detection volume is to estimate the 1/e²-radius ω by measuring the diffusion time of a dye with known diffusion coefficient, from which the volume is calculated using V=π^{3/2}·ω³·S, where S=z/ω) is the structure parameter and z is the half-height of the detection volume. However, in FCS the measured diffusion times are relatively weakly influenced by z, wherefore it is often difficult to estimate S. Furthermore viscosity and temperature affect the diffusion coefficient of the calibration dye and must therefore be known or controlled. In contrast, with iFCCS and by use of eq. 5 an estimate of V_{g} is obtained from the size ratio between the sphere and the detection volume, independent of the viscosity, temperature or the shape of the detection volume. Especially estimations of detection volumes for which no analytical expressions describe their shape (Foquet et al., 2008) will benefit from the approach described here.

The factor

$$\sqrt{\frac{{V}_{g}}{{V}_{r}}}$$

appears because two-color cross-correlation measurements are performed with different sizes of the green and the red detection volumes. However a single laser line is sufficient, if measurements can be carried out on red-labeled particles that can be sufficiently excited with the same green laser line as is used for exciting the medium. Using pinholes of the same size for the two detection channels, an estimate of V_{qg}, and thus of Vₚₐᵣₜ or V_{g}, can be obtained without requiring estimation of

$$\sqrt{\frac{{V}_{g}}{{V}_{r}}} .$$

Since cross-talk was present in our measurements on fluospheres (FIG. 11), eq. 5 could not be applied. However the detection volume can still be estimated by applying an approximation of eq. 4. Since I_{ct}·V_{qg}<<Qₚ, and since V_{qg}=Vₚₐᵣₜ/V_{g}≈0.03 and N_{pg}<0.1 imply that (1−N_{pg}·V_{qg})−1 (compare eq. 4), a valid approximation of eq. 4 is

$${G}_{cc} ( 0 ) - 1 = \frac{- {Q}_{p} \cdot {N}_{pg} \cdot {V}_{qg} \cdot \sqrt{\frac{{V}_{r}}{{V}_{g}}}}{{I}_{ct} + {Q}_{p} \cdot {N}_{pg} \cdot \frac{{V}_{r}}{{V}_{g}}} \qquad ( 6 )$$

Solving eq. 6 for V_{qg} and replacing V_{qg} by Vₚₐᵣₜ/V_{g} gives

$${V}_{g} = \frac{- {Q}_{p} \cdot {N}_{pg} \cdot {V}_{part} \cdot \sqrt{\frac{{V}_{r}}{{V}_{g}}}}{( {G}_{cc} ( 0 ) - 1 ) \cdot ( {I}_{ct} + {Q}_{p} \cdot {N}_{pg} \cdot \frac{{V}_{r}}{{V}_{g}} )} = \frac{- ( {I}_{r} - {I}_{ct} ) \cdot {V}_{part} \cdot \sqrt{\frac{{V}_{g}}{{V}_{r}}}}{( {G}_{cc} ( 0 ) - 1 ) \cdot {I}_{r}} \qquad ( 7 )$$

where the total intensity in the red channel

$${I}_{r} = {I}_{ct} + {Q}_{p} \cdot {N}_{pg} \cdot \frac{{V}_{r}}{{V}_{g}} .$$

The factor

$$\sqrt{\frac{{V}_{g}}{{V}_{r}}}$$

(eq. 7) is needed to give an estimate of the size ratio between V_{g} and Vᵣ. By comparing the diffusion time of RPE measured with 458 nm excitation with the diffusion time of RPE measured with 543 nm excitation, using the same pinhole settings as were used in the iFCCS-measurements on fluospheres,

$$\sqrt{\frac{{V}_{g}}{{V}_{r}}}$$

was estimated to 0.66 (Vᵣ/V_{g}=2.28). The curves (FIG. 11) give together with eq. 7 the values 0.159, 0.169, 0.166, 0.176, 0.155 and 0.250 fl respectively for V_{g}. Since the clearly deviating value 0.250 fl is derived from the measurement on the most dilute sample (less than 10 transits of fluospheres per minute), we assume here that it is non-representative. The remaining values give

V_{g}=0.165±0.008 fl

where the error is standard deviation. For comparison we estimated the detection volume using alexa 488 (D=414 μm²/s (Petrasek and Schwille, 2008)) with a measured diffusion time of 16.8 μs (458 nm excitation was used) and a mean structure parameter S=5.9, using V=π^{3/2}·ω³·S. This gives V_{g}=0.153±0.02 fl which agrees very well with the estimation above from iFCCS on fluospheres. The traditional estimation gives a larger standard deviation which is the result of uncertainty in the estimated structure parameter S. It should be pointed out that our measurements were carried out using a diffraction limited detection volume, in which case the structure parameter S usually can be estimated. For larger detection volumes however, with defocused laser excitation and using pinholes of ≧100 μm diameter, a value of S can often not be obtained.

The fact that different iFCCS-measurements give so similar values for the size of the detection volume means that, conversely, if the size of the detection volume is estimated beforehand, then the volume of the analyzed particles or biomolecules can be estimated very precisely.

To test the ability of iFCCS to detect the interaction between a small dye-labeled ligand and a large binding partner, non-fluorescent streptavidin coated polystyrene beads were mixed with biotin-tagged R-Phycoerythrin (RPE-biotin). The non-fluorescent spheres become fluorescent upon binding to RPE, causing the negative spikes in the medium-channel to coincide with positive spikes in the RPE-channel. Streptavidin-coated spheres were measured in the presence of 60 nM RPE as control (FIG. 13A), and in the presence of 15, 30 or 60 nM of RPE-biotin (FIG. 13B-D). iFCCS-measurements were initiated 2-3 minutes after mixing. Positive spikes in the red channel that coincided with negative spikes in the green channel were observed (FIG. 13 B-D), and the frequency of coinciding spike-pairs increased with increasing RPE-biotin concentration.

The fraction of negative spikes that coincide with a positive spike is a direct estimate of the fraction of streptavidinized beads that carry an RPE-biotin label. One way of determining this fraction is to estimate the concentration of labeled beads from the amplitude of the component with longer diffusion time τ_{diff} of the red FCS-curve, and compare this estimate with the total number of beads (labeled and unlabeled), obtained from the amplitude of the iFCS-curve. The brightness of labeled beads is however different from that of unbound ligands, and the estimation of the labeled beads' concentration is so sensitive to the used value for brightness of free ligand that this approach becomes unreliable. For analysis we therefore simply counted the number of negative spikes in the green channel that coincided with a positive spike in the red channel. Since cross-talk is present from the green, medium signal to the red channel, the transits of beads not carrying any RPE result in negative spikes also in the red channel (FIG. 13A). Therefore, when indeed an increase in intensity in the red channel is found to coincide with a negative spike in the green channel, this provides a sufficient criterion for the detection of a labeled bead.

In addition to negative spikes in the green channel without coinciding spikes in the red channel, which correspond to unlabeled beads, positive spikes in the red channel were observed that did not coincide with a negative spike in the green channel (FIG. 13B-D). These are likely the result of free streptavidin molecules detached from the microspheres, able to bind up to four RPE-biotin molecules. Because of their limited volume they generate however no negative spikes in the medium-channel.

The fraction of the negative spikes that coincided with a positive spike was 30% (27 of 91) at 15 nM RPE-biotin, 41% (38 of 92) at 30 nM RPE-biotin, and 58% (62 of 106) at 60 nM RPE-biotin. In a control measurement on 60 nM RPE without biotin mixed with streptavidin coated spheres, 8% (6 of 74) of the negative spikes coincided with a positive spike (FIG. 13 A).

Measurements in reduced detection volumes using zero mode waveguides show that significantly smaller particles and even protein molecules can be analyzed by iFCS. This will allow iFCCS to be significantly extended to different types of applications. iFCCS enables direct estimation of the volume of protein molecules, and cross-correlation can be used as the indication of binding between ligands and unlabeled protein molecules. For example in FCS-based assays for high-throughput screening (HTS), standard FCCS is not used because of its requirement that both binding partners must be labeled (Eggeling et al., 2003). iFCCS has the potential to circumvent this requirement. Also, iFCS is an alternative to dynamic light scattering (DLS) for label-free analysis of proteins, with the advantage of allowing analysis at ˜nM concentrations instead of ˜10 (Muller et al., 2009).

An iFCCS-measurement on labeled particles gives a direct estimate of the labeled particles' average volume, however the same measurement also gives an estimate of the particles diffusion coefficient from the measured diffusion time τ_{diff}. Since the diffusion coefficient is dependent not only on the size of particles but also on their shape, comparison between τ_{diff} and the particles volume Vₚₐᵣₜ should give information about the particles' shape.

In summary, iFCCS makes two new analyses possible: First, labeled particles/biomolecules can be analyzed, which gives information about the size ratio between the analyzed particles/biomolecules and the detection volume. This ratio can be used to estimate the volume of the particles/biomolecules, without any assumptions about their shape, or it can be used to estimate the size of the detection volume, without any assumptions about the detection volume's shape. Secondly, the interaction of small, labeled ligands with larger unlabeled particles/biomolecules can be studied. Binding between ligands and particles/biomolecules gives rise to anti-correlation, a sensitive indication of binding, without requiring labeling of the particle/biomolecule. Omitting labeling saves time, and the risk of perturbing the analyzed particles/biomolecules is avoided. Using iFCCS in such a binding-assay can also give accurate estimation of the degree of labeling of particles/biomolecules. This could be very useful for testing the success of post-translational labeling of proteins.

### REFERENCES

Bacia, K., Kim, S. A. and Schwille, P. (2006) Fluorescence cross-correlation spectroscopy in living cells. Nature Methods, 3, 83-89.
Bonnet, G., Krichevsky, O. and Libchaber, A. (1998) Kinetics of conformational fluctuations in DNA hairpin-loops. Proceedings of the National Academy of Sciences of the United States of America, 95, 8602-8606.
Chen, Y., Muller, J. D., So, P. T. C. and Gratton, E. (1999) The photon counting histogram in fluorescence fluctuation spectroscopy. Biophysical Journal, 77, 553-567.
Eggeling, C., Brand, L., Ullmann, D. and Jager, S. (2003) Highly sensitive fluorescence detection technology currently available for HTS. Drug Discovery Today, 8, 632-641.
Elson, E. L., Magde, D. (1974) Fluorescence correlation spectroscopy. I. Conceptual basis and theory. Biopolymers, 13, 1-27.
Foquet, M., Samiee, K. T., Kong, X. X., Chauduri, B. P., Lundquist, P. M., Turner, S.W., Freudenthal, J. and Roitman, D. B. (2008) Improved fabrication of zero-mode waveguides for single-molecule detection. Journal of Applied Physics, 103,-.
Hell, S.W. (2003) Toward fluorescence nanoscopy. Nature Biotechnology, 21, 1347-1355.
Kask, P., Palo, K., Ullmann, D. and Gall, K. (1999) Fluorescence-intensity distribution analysis and its application in biomolecular detection technology. Proceedings of the National Academy of Sciences of the United States of America, 96, 13756-13761.
Kastrup, L., Blom, H., Eggeling, C. and Hell, S.W. (2005) Fluorescence Fluctuation Spectroscopy in Subdiffraction Focal Volumes. Physical Review Letters, 94, 178104-178104.
Kinjo, M. and Rigler, R. (1995) Ultrasensitive Hybridization Analysis Using Fluorescence Correlation Spectroscopy. Nucleic Acids Research, 23, 1795-1799.
Magde, D., Elson, E. and Webb, W. W. (1972) Thermodynamic Fluctuations in a Reacting System—Measurement by Fluorescence Correlation Spectroscopy. Physical Review Letters, 29, 705-708.
Meseth, U., Wohland, T., Rigler, R. and Vogel, H. (1999) Resolution of fluorescence correlation measurements. Biophysical Journal, 76, 1619-1631.
Muller, C. B., Eckert, T., Loman, A., Enderlein, J. and Richtering, W. (2009) Dual-focus fluorescence correlation spectroscopy: a robust tool for studying molecular crowding. Soft Matter, 5, 1358-1366.
Petrasek, Z. and Schwille, P. (2008) Precise measurement of diffusion coefficients using scanning fluorescence correlation spectroscopy. Biophysical Journal, 94, 1437-1448.
Provencher, S.W. (1982) A Constrained Regularization Method for Inverting Data Represented by Linear Algebraic or Integral-Equations. Computer Physics Communications, 27, 213-227.
Rigler, R., Mets, U., Widengren, J. and Kask, P. (1993) Fluorescence Correlation Spectroscopy with High Count Rate and Low-Background—Analysis of Translational Diffusion. European Biophysics Journal with Biophysics Letters, 22, 169-175.
Schwille, P., MeyerAlmes, F. J. and Rigler, R. (1997) Dual-color fluorescence cross-correlation spectroscopy for multicomponent diffusional analysis in solution. Biophysical Journal, 72, 1878-1886.
Starchev, K., Zhang, J.W. and Buffle, J. (1998) Applications of fluorescence correlation spectroscopy—Particle size effect. Journal of Colloid and Interface Science, 203, 189-196.
Wu, B., Chen, Y. and Muller, J. D. (2008) Fluorescence correlation spectroscopy of finite-sized particles. Biophysical Journal, 94, 2800-2808.

1-56. (canceled)

57. A method for analyzing a sample, comprising:
detecting at least one signal and fluctuations in the at least one signal from at least one detection volume of the sample; wherein the at least one signal is generated from signal-generating agents in the medium surrounding an analyte and the fluctuations are reductions in the at least one signal generated due to the presence of the analyte in the at least one detection volume; and
analyzing the detected fluctuations to obtain information about the analyte in the sample.

58. A method according to claim 57, wherein the sample is a solid sample and the fluctuations are generated by means of scanning the detection volume in the sample.

59. A method according to claim 57, wherein the sample is a liquid sample and the fluctuations are transient reductions in the at least one signal as the analyte transits through the detection volume.

60. A method according to claim 57, wherein the at least one signal is a fluorescence signal from the signal-generating agents in the medium.

61. A method according to claim 60, wherein the signal-generating agents in the medium are fluorescent dye molecules.

62. A method according to claim 57, wherein the at least one signal is a Raman scattering signal.

63. A method according to claim 62, wherein the signal-generating agents are carbon disulfide, isoprene, transition-metal complexes or water.

64. A method according to claim 62, wherein the at least one signal is generated by exciting the signal-generating agents in the medium by means of UV-light.

65. A method according to claim 57, wherein the at least one detection volume is restricted by the dimensions of a laser focus.

66. A method according to claim 65, wherein the detection volume is between 0.01-1.0 fl.

67. A method according to claim 57, wherein the at least one detection volume is defined by utilizing STED-microscopy or zero mode waveguides.

68. A method according to claim 57, wherein analyzing the detected fluctuations comprises calculating the autocorrelation function (ACF) or calculating the standard deviation of the detected fluctuations.

69. A method according to claim 57, wherein analyzing the detected fluctuations comprises intensity distribution analyses such as Photon Counting Histogram (PCH) and Fluorescence Intensity Distribution analysis (FIDA).

70. A method according to claim 57, wherein the concentration of the signal-generating agents in the medium is above 1 μM.

71. A method according to claim 57, wherein the concentration of the analyte in the sample is between 0.5 nM and 1.0 mM.

72. A method according to claim 57, further comprising:
simultaneously detecting a second or further signal and fluctuations in the second or further signal from the at least one detection volume; wherein the second or further signal is generated from second or further signal-generating agents in the sample and the fluctuations are transient bursts in the second or further signal as the second or further signal-generating agents transit through the at least one detection volume; and wherein
analyzing the detected fluctuations comprises correlating the detected at least one signal from the signal-generating agents in the medium with the detected fluctuations in the second or further signal from the second or further signal-generating agents to obtain information about the analyte in the sample.

73. A method according to claim 72, wherein the second or further signal-generating agents are the analyte.

74. A method according to 72, wherein the second or further signal comprise a fluorescence signal or a Raman signal from the second or further signal-generating agents.

75. A method according to claim 57, wherein the analyte is unlabeled.

76. A method according to claim 57, wherein the analyte is labeled.

77. A method according to claim 57 for analyzing particles or biomolecules in a liquid sample, comprising:
detecting a signal and fluctuations in the signal from a detection volume in the sample; wherein the signal is generated from signal-generating molecules in the medium surrounding the particles or biomolecules and the fluctuations are transient reductions in the signal as the particles or biomolecules transit through the detection volume; and
analyzing the detected fluctuations to obtain information about the particles or biomolecules in the liquid sample.

78. A method according to claim 77, wherein the concentration of the particles or biomolecules is below 1.1 nM.

79. A method according to claim 57 for analyzing molecules in a solid material, comprising
scanning a detection volume across the solid material;
detecting a signal generated from the solid material and fluctuations in the signal; wherein the fluctuations arise as reductions in the signal when the molecules are present in the detection volume; and
analyzing the detected fluctuations in the signal from the solid material to obtain information about the molecules.

80. A method according to claim 79, wherein the molecules are selected from the group consisting of particles and biomolecules.

81. A spectroscopy system comprising a laser, a zero-mode waveguide, guiding means for guiding the laser into the zero-mode waveguide, means for collecting at least one signal from excited agents or a scattering signal within the waveguide, detecting means for detecting the at least one signal and means for analyzing the detected at least one signal, wherein the detecting means comprises a photomultiplier tube or a simple photodiode.

82. The spectroscopy system according to claim 81, wherein the at least one signal is a fluorescence signal and/or a Raman scattering signal.

83. The system according to claim 81, wherein the photomultiplier tube is in DC-mode.

84. The system according to claim 81, wherein the means for analyzing the detected at least one signal comprises autocorrelation means.

85. A method of using a spectroscopy system for analyzing molecules of interest in a sample, comprising detecting and analyzing fluctuations in at least one signal that is generated from sample agents surrounding the molecules of interest, wherein the fluctuations are transient reductions in the detected at least one signal.

86. A method according to claim 85, wherein the at least one signal is a fluorescence signal and/or a Raman scattering signal.

87. A method according to claim 85, wherein the system further comprises a zero-mode waveguide.

88. A method according to claim 85, wherein the detecting means comprises a photomultiplier tube or a simple photodiode.

89. A method according to claim 85, wherein the means for analyzing the detected at least one signal comprises autocorrelation means

90. A method according to claim 85, wherein the system comprises a laser, guiding means for guiding the laser into a sample, means for collecting fluorescence emission from the sample, a detector for detecting the fluorescence emission and means for autocorrelating the detected fluorescence signal.
